(19) United States
(12) Patent Application Publication
(10) Pub. No.: US 2014/0297276 A1
(43) Pub. Date: Oct. 2, 2014

(54) EDITING APPARATUS, EDITING METHOD, AND COMPUTER PROGRAM PRODUCT

(71) Applicant: KABUSHIKI KAISHA TOSHIBA, Tokyo (JP)

(72) Inventor: Mitsuyoshi TACHIMORI, Kawasaki-shi (JP)

(73) Assignee: KABUSHIKI KAISHA TOSHIBA, Tokyo (JP)

(21) Appl. No.: 14/188,021

(22) Filed: Feb. 24, 2014

(30) Foreign Application Priority Data
Apr. 2, 2013 (JP) 2013-077190

(51) Int. Cl. G06F 17/24; G10L 15/26

(52) U.S. Cl. CPC G06F 17/24; G10L 15/26
USPC 704/235

(57) ABSTRACT

According to an embodiment, an editing apparatus includes a receiver and a controller. The receiver is configured to receive input data. The controller is configured to produce one or more operable target objects from the input data, receive operation through a screen, and produce an editing result object by performing editing processing on the target object designated in the operation.

### CROSS-REFERENCE TO RELATED APPLICATION

This application is based upon and claims the benefit of priority from Japanese Patent Application No. 2013-077190, filed on Apr. 2, 2013; the entire contents of which are incorporated herein by reference.

### FIELD

Embodiments described herein relate generally to an editing apparatus, an editing method, and a computer program product.

### BACKGROUND

With an increase in downsizing of information terminals, voice input has been widely used. For example, the voice input is used for various services such as information input, information search, and language translation. The voice input, however, has a problem of false recognition. Methods of correcting false recognition have been proposed.

The conventional methods, however, require complicated operation for correction, and thus lack user-friendliness.

### BRIEF DESCRIPTION OF THE DRAWINGS

FIG. 1 is an exemplary schematic diagram illustrating a functional structure of an editing apparatus according to a first embodiment;

FIG. 2 is an exemplary schematic diagram illustrating displays of objects in the first embodiment;

FIGS. 3A and 3B are exemplary schematic diagrams illustrating operation to connect the objects in the first embodiment;

FIGS. 4A and 4B are exemplary schematic diagrams illustrating operation to combine the objects in the first embodiment;

FIGS. 5A and 5B are exemplary schematic diagrams illustrating operation to divide the object in the first embodiment;

FIG. 6 is an exemplary schematic diagram illustrating data of a touch event in the first embodiment;

FIG. 7 is an exemplary flowchart illustrating a processing procedure of the editing apparatus in the first embodiment;

FIG. 8 is an exemplary flowchart illustrating a processing procedure of a multi-touch detection routine in the first embodiment;

FIG. 9A is an exemplary flowchart illustrating a processing procedure of a connection routine in the first embodiment;

FIG. 9B is an exemplary Japanese statement used in the first embodiment;

FIG. 10 is an exemplary flowchart illustrating a processing procedure to produce a corrected sentence in the first embodiment;

FIG. 11 is an exemplary conceptual diagram of a lattice output as a morphological analysis in the first embodiment;

FIGS. 12A and 12B are exemplary schematic diagrams illustrating the addition of paths to the lattice in the first embodiment;

FIG. 13 is an exemplary flowchart illustrating a processing procedure of a combination routine in the first embodiment;

FIG. 14 is an exemplary flowchart illustrating a processing procedure of an operation target object extraction routine in the first embodiment;

FIG. 15 is an exemplary flowchart illustrating a processing procedure of a touch event processing routine in the first embodiment;

FIG. 16 is an exemplary flowchart illustrating a processing procedure of a combined object production routine in the first embodiment;

FIG. 17 is an exemplary flowchart illustrating a processing procedure of a division routine in the first embodiment;

FIG. 18 is an exemplary flowchart illustrating a processing procedure of an object division routine in the first embodiment;

FIG. 19 is an exemplary conceptual diagram of divided areas in the first embodiment;

FIG. 20 is an exemplary schematic diagram illustrating the division of the object in the first embodiment;

FIG. 21 is an exemplary flowchart illustrating a processing procedure of an insertion-connection routine according to a first modification;

FIG. 22 is a first exemplary flowchart illustrating a procedure of processing to determine the connecting order of two objects according to a second modification;

FIG. 23 is a second exemplary flowchart illustrating the procedure of processing to determine the connecting order of two objects in the second modification;

FIG. 24 is an exemplary flowchart illustrating a procedure of processing to determine the combining order of three objects in the second modification;

FIG. 25 is an exemplary schematic diagram illustrating provision of a translation service;

FIG. 26 is an exemplary schematic diagram illustrating a functional structure of the editing apparatus according to a second embodiment;

FIG. 27 is an exemplary flowchart illustrating a processing procedure of the editing apparatus in the second embodiment;

FIGS. 28A to 28D are exemplary schematic diagrams illustrating provision of a product management service; and

FIG. 29 is an exemplary schematic diagram illustrating a structure of the editing apparatus in the embodiments.

### DETAILED DESCRIPTION

According to an embodiment, an editing apparatus includes a receiver and a controller. The receiver is configured to receive input data. The controller is configured to produce one or more operable target objects from the input data, receive operation through a screen, and produce an editing result object by performing editing processing on the target object designated in the operation.

The following describes embodiments of an editing apparatus, an editing method, and an editing program in detail with reference to the accompanying drawings.

### First Embodiment

### Overview

The following describes a function (editing function) of an editing apparatus according to a first embodiment. The editing apparatus in the first embodiment produces from input data one or a plurality of objects (operation target objects) operable in editing. The editing apparatus in the embodiment displays the produced objects and receives gesture operation (intuitive editing operation) that instructs a connection or a combination of the objects, or a division of the object. The editing apparatus in the embodiment performs editing processing of the connection or the combination on the objects designated in the operation, or the division on the object designated in the operation in accordance with the received operation and produces a new object or new objects (editing result object or editing result objects) corresponding to the editing result. The editing apparatus in the embodiment then displays the produced new object (or produced new objects) and updates a content of an editing screen to the content in which the editing operation is reflected. In this way, the editing apparatus in the embodiment can achieve the intuitive editing operation. The editing apparatus in the embodiment has such an editing function.

An example of the conventional methods designates false recognition using some kind of ways and corrects the false recognition by correct input after the erasing of the false recognition. Another example of the conventional methods displays alternative candidates for the false recognition and corrects the false recognition by the selection of the alternative from the candidates. Those methods, however, need some key operation for the correction. Such operation is cumbersome to the compact information terminals recently in widespread use.

The information terminals, such as smartphones or tablets, which have touch sensors on display screens thereof, enable the gesture operation in accordance with human intuition. It is preferable for such information terminals to enable false recognition to be also corrected by the intuitive operation and editing to be readily made.

The editing apparatus in the embodiment produces the objects each serve as an editing operation unit from the input data and edits the produced objects in accordance with the gesture operation received through the display screen.

The editing apparatus in the embodiment thus can achieve the intuitive operation on the input data, thereby making it easy to perform the editing operation. As a result, a burden in editing work such as the correction of false recognition can be reduced. Consequently, the editing apparatus in the embodiment can enhance the convenience of a user (e.g., an “editor”).

The following describes a structure and operation of the function of the editing apparatus in the embodiment. The following description is made on an exemplary case where a text sentence is edited that is produced from the recognition result of an input voice.

Structure

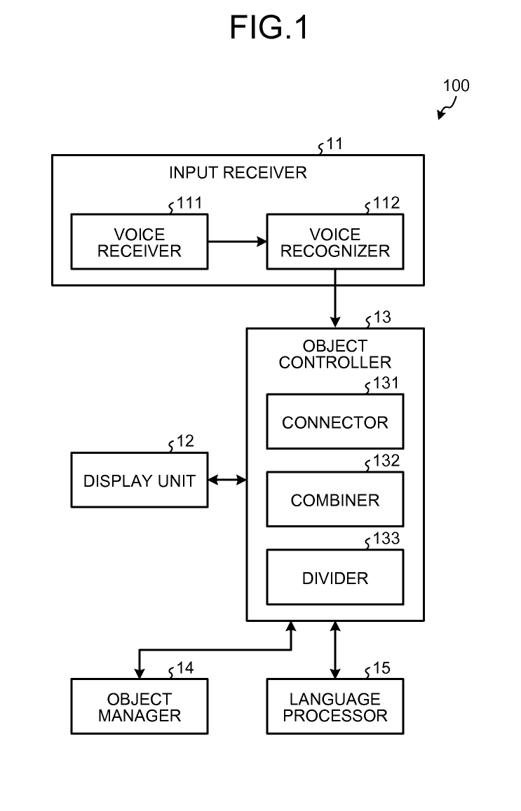

FIG. 1 is a schematic diagram illustrating a functional structure of an editing apparatus 100 in the embodiment. As illustrated in FIG. 1, the editing apparatus 100 in the embodiment comprises an input receiver 11, a display unit 12, an object controller 13, an object manager 14, and a language processor 15.

The input receiver 11 receives input data. The input receiver 11 in the embodiment receives the input data by producing text enabling humans to read an utterance sentence from the recognition result of a voice. The input receiver 11 thus comprises a voice receiver 111 that receives voice input and a voice recognizer 112 that recognizes an input voice, produces text from the recognition result, and outputs the text. The voice receiver 111 receives a voice signal from a microphone and outputs digitalized voice data, for example. The voice recognizer 112 receives the output voice data, detects for example the separations of sentences by voice recognition, and obtains the recognition results of the respective detected separations. The voice recognizer 112 outputs the obtained recognition results. As a result, the input receiver 11 uses the text produced from the recognition results as the input data.

The display unit 12 displays various types of information on a display screen such as a display, for example. The display unit 12 detects operation (e.g., a “contact condition of an operation point” and a “movement of the operation point”) on the screen by a touch sensor and receives an operation instruction from the detection result, for example. The display unit 12 in the embodiment displays one or a plurality of objects operable in editing and receives various types of editing operation such as the connection or the combination of the objects or the division of the object.

The object controller 13 controls the editing of one or more objects operable in editing. The object controller 13 produces one or more objects operable in editing (each object serves as an editable operation unit) from the input data (text) received by the input receiver 11. The object controller 13 produces one object per recognition result of the voice recognizer 112. In other words, the object controller 13 produces the operation target object in editing for each recognition result. The display unit 12 displays the produced objects. The object controller 13 performs editing processing of the connection or the combination of the produced objects or the division of the produced object. The object controller 13 performs the editing processing of the connection or the combination on the objects designated in the operation or the division on the object designated in the operation in accordance with the operation instruction received by the display unit 12 and produces a new object or new objects. The object controller 13 thus comprises a connector 131, a combiner 132, and a divider 133. The connector 131 connects two objects to each other and produces a new object (connected object). The combiner 132 combines two or more objects and produces a new object (combined object). The divider 133 divides one object into a plurality of pieces and produces two or more objects (divided objects). In other words, the object controller 13 produces the editing result object or the editing result objects for each editing operation. The new object thus produced is or the new objects thus produced are displayed on the screen by the display unit 12, resulting in a content of an editing screen being updated to the content in which the editing operation is reflected.

The following describes the objects produced by the object controller 13. The object, which serves as the operation target in editing, is data having an attribute of the recognition result and another attribute of a display area displaying the recognition result. The object produced when text is output as the recognition result (hereinafter referred to as an “object O”) has two attributes of a sentence attribute and a shape attribute, for example. In this case, the value of the sentence attribute (hereinafter referred to as a “sentence S”) is a sentence (recognition result) expressed with text (characters or character strings). The value of the shape attribute is coordinates representing the shape of the display area in which the text is displayed on the screen. Specifically, the value is a set of two coordinate points of P and Q in a coordinate system having the origin at the upper left corner in the screen, x-axis whose positive direction is rightward in the horizontal direction, and the y-axis whose positive direction is downward in the vertical direction. They are expressed as P=(x1, y1) and Q=(x2, y2) in the coordinate system (x1<x2 and y1<y2). The set of the coordinate points of P and Q is hereinafter referred to as a “shape [P, Q]”. The two coordinate values of the shape attribute uniquely determine a rectangle having four corners of the upper left corner (x1, y1), the upper right corner (x2, y1), the lower right corner (x2, y2) and the lower left corner (x1, y2). The shape [P, Q] represents that the area (object area) of the object O is a rectangle. In the following description, the object O, which has the values of the respective attributes, the sentence S and the shape [P, Q], is expressed as {S, [P, Q]}. The midpoint of the coordinate points P and Q (=(P+Q)/2) is referred to as the center point of the object O or the coordinates of the object O. When the object O has the recognition result as the sentence S, the state is expressed as “the sentence S associated with the object O” or “the object O associated with the sentence S”.

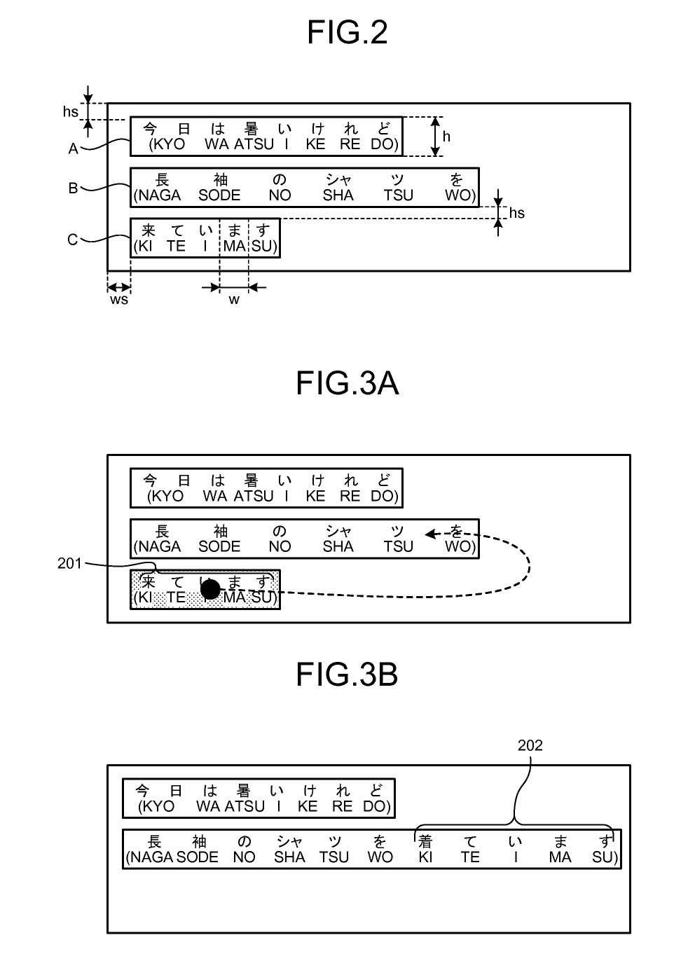

The shape attribute [P, Q] of the object O is determined in the following manner. FIG. 2 is a schematic diagram illustrating examples of displays of objects in the embodiment. FIG. 2 illustrates the exemplary displays of the objects, which are associated with three respective sentences of A, B, and C corresponding to the respective recognition results. In this case, all of the characters have the same width w and the same height h and the sentence S associated with the object O is a character string having n characters.

The coordinate point Q is expressed (calculated) by the following Equations (1) and (2).

x coordinate of Q=x coordinate of coordinate point P+w×n (1)

where w is the width of character, and n is the number of characters.

y coordinate of Q=y coordinate of coordinate point P+h (2)

where h is the height of character.

The coordinate point P is expressed (calculated) by the following Equations (3) and (4) when N objects are displayed.

x coordinate of P=ws (3)

where ws is the distance from the left end of the screen to the object O.

y coordinate of P=N×h+N×hs (4)

where N is the number of objects, h is the height of character, and hs is the spacing between objects.

In this way, the objects produced by the object controller 13 are sequentially displayed with the certain distance ws from the left end of the screen to the right with the certain spacing hs therebetween. Thus, the sentence S corresponding to the recognition result is displayed in horizontal writing inside the rectangle [P, Q] of the object O.

The screen width has a limit. In the determination of the coordinates as described above, the object O may be out of the screen in the vertical direction when the number n of characters of the sentence S exceeds the lateral width of the screen or the number N of objects displayed on the screen is increased, for example. In such a case, the display unit 12 may perform the following display processing. When the object O is displayed under the lower end of the screen, the screen is scrolled up by the height h of the object O such that the object O is displayed on the screen, for example. When part of the horizontal width (w×n) of the object O is out of the screen, a plurality of lines each having the height h of the object O are provided such that the object O is fully displayed in the screen. In this way, the display unit 12 may perform processing such that the object O is fully displayed in the screen in accordance with the screen area in which the object O is to be displayed.

Referring back to FIG. 1, the object manager 14 manages the objects. The object manager 14 receives the produced objects from the object controller 13 and stores and saves them in a storage area. The storage area for the objects is a certain storage area in a storage device comprised in the editing apparatus 100, for example. The object manager 14 performs various types of data operation on the objects, such as data reference, data read, or data write, in accordance with the instructions from the object controller 13.

The language processor 15 performs language processing on the sentence S corresponding to the recognition result. The language processor 15 breaks down the sentence S into certain units such as words or morphemes, for example. The language processor 15 performs a grammatical correction such as correction of characters or insertion of punctuation marks on the sentence S after the breakdown by the processing according to the language.

The following describes the editing operation achieved by the cooperative operation of the respective functional modules described above.

Operation Example

The editing function in the embodiment provides an environment where various types of editing operation of the connection, the combination, and the division can be performed on an object. The connection operation on an object is the operation that connects two objects and produces a new object (connected object). The combination operation on an object is the operation that combines two or more objects and produces a new object (combined object). The division operation on an object is the operation that divides one object and produces two or more objects (divided objects). In this way, the editing function in the embodiment provides an environment where the intuitive editing operation can be achieved.

FIGS. 3A and 3B are schematic diagrams illustrating an example of the connection operation on an object in the embodiment. When two objects are connected, as illustrated in FIG. 3A, a user first touches the object O displayed on the screen with a finger (the touched condition is indicated with the filled circle in FIG. 3A) to designate the object O that the user wishes to connect to the other object. The user then moves the finger toward the other object serving as the destination of the connection while keeping the finger touched on the screen (the trace of the movement is indicated with the dotted line in FIG. 3A) and thereafter lifts the finger at the object O serving as the destination to instruct the connection operation on the objects. When receiving the instruction, the object controller 13 connects the two objects to each other in accordance with the received instruction. The language processor 15 performs grammatical character correction on the new object after the connection. As a result, as illustrated in FIG. 3B, the respective sentences S corresponding to the two objects are displayed on the screen as one sentence after the character correction (the connected sentence in which the sentence 201 (which means come in English) is corrected to the sentence 202 (which means wear in English), the sentence 201 and 202 are both pronounced with “kite imasu” in Japanese).

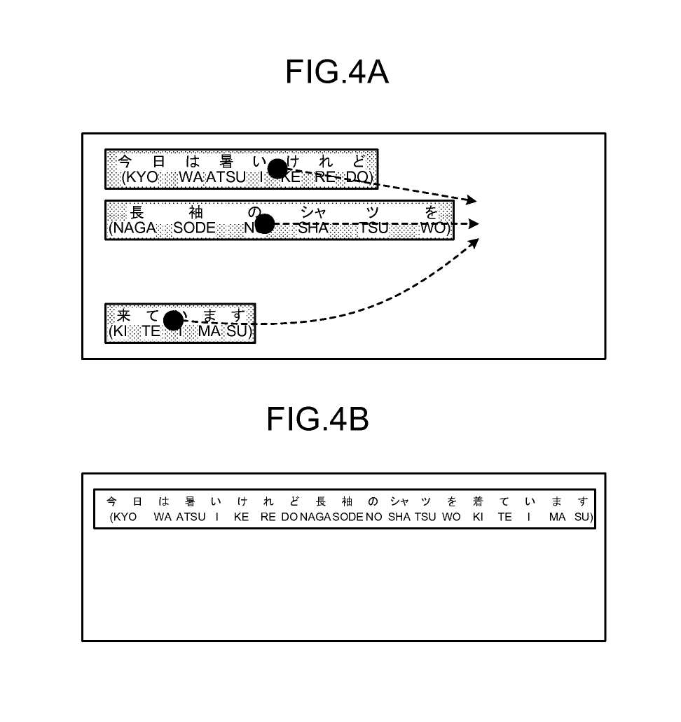

FIGS. 4A and 4B are schematic diagrams illustrating an example of the combination operation on the objects in the embodiment. When the three objects are combined, as illustrated in FIG. 4A, a user first touches the objects displayed on the screen with respective fingers (the filled circles in FIG. 4A) to designate the respective objects to be combined. The user then moves the three fingers to the same position on the screen while keeping the three fingers touched on the screen (the dotted lines in FIG. 4A) and thereafter lifts the three fingers at the position to instruct the combination processing on the objects. When receiving the instruction, the object controller 13 combines the three objects in accordance with the received instruction. The language processor 15 performs grammatical character correction on the new object after the combination. As a result, as illustrated in FIG. 4B, the respective sentences S corresponding to the three objects are displayed on the screen as one sentence after the character correction (combined sentence).

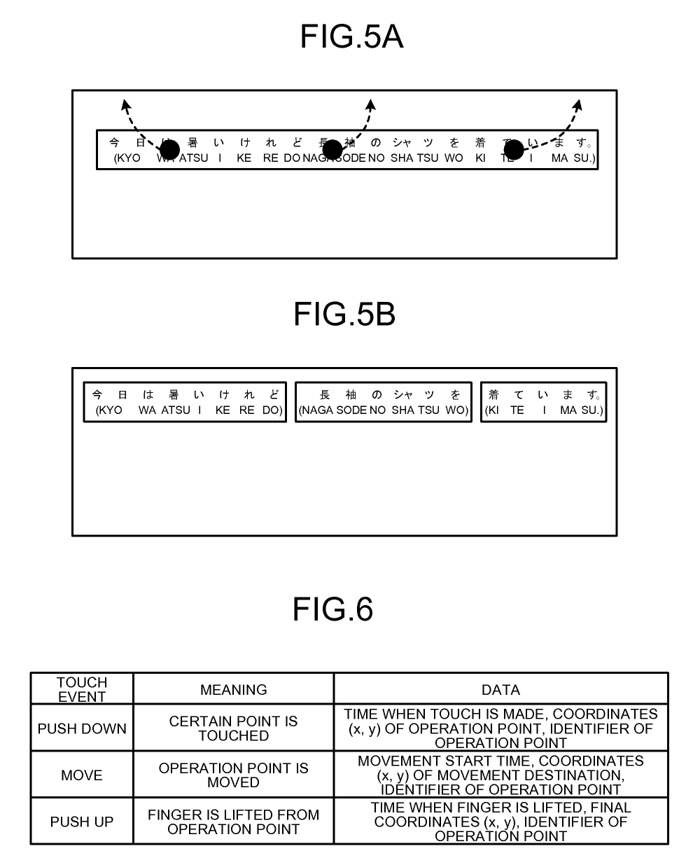

FIGS. 5A and 5B are schematic diagrams illustrating an example of the division operation on an object in the embodiment. When the object is divided into three new objects, as illustrated in FIG. 5A, a user first touches the object displayed on the screen with three fingers (the filled circles in FIG. 5A) to designate new objects after the division. The user then moves the three fingers to different positions from each other on the screen while keeping the three fingers touched on the screen (the dotted lines in FIG. 5A) and thereafter lifts the three fingers at the positions to instruct the division processing on the object. When receiving the instruction, the object controller 13 divides the object into three new objects in accordance with the received instruction. As a result, as illustrated in FIG. 5B, the sentence S associated with the object is displayed on the screen as the designated three sentences (divided sentences).

Such editing operation is achieved in the following manner. The display unit 12 detects the operation points, such as fingers, on the screen (the touched coordinates on the screen) by the touch sensor to receive the operation on the screen, for example. The display unit 12 notifies the object controller 13 of the operation received in this way as operation events. The object controller 13 then identifies the operation event for each of the detected operation point. As a result, the object controller 13 identifies a touch event, such as a touch of a finger on a certain point on the screen, a movement of a finger to a certain point on the screen, or a lifting of a finger from a certain point on the screen in the gesture operation, and acquires the touch event and information corresponding to the event, for example.

FIG. 6 is a schematic diagram illustrating an example of data of the touch events in the embodiment. The object controller 13 acquires data illustrated in FIG. 6, which data corresponds to the respective touch events. When the touch event is a “push down”, the time when the touch is made, the coordinates (x, y) of the operation point on the screen, and an identifier of the operation point are acquired as the data, for example. When the touch event is a “move”, the movement start time, the coordinates (x, y) of the movement destination on the screen, and the identifier of the operation point are acquired as the data, for example. When the touch event is a “push up”, the time when a finger is lifted, the final coordinates (x, y) of the operation point on the screen, and the identifier of the operation point are acquired as the data, for example. Such information can be acquired through an application program interface (API) included in basic software, such as an operating system (OS), or a multi-touch platform, for example. In other words, the object controller 13 can acquire information about the received editing operation using known systems.

The following describes basic processing of the editing function performed by the editing apparatus 100 in the embodiment.

Processing

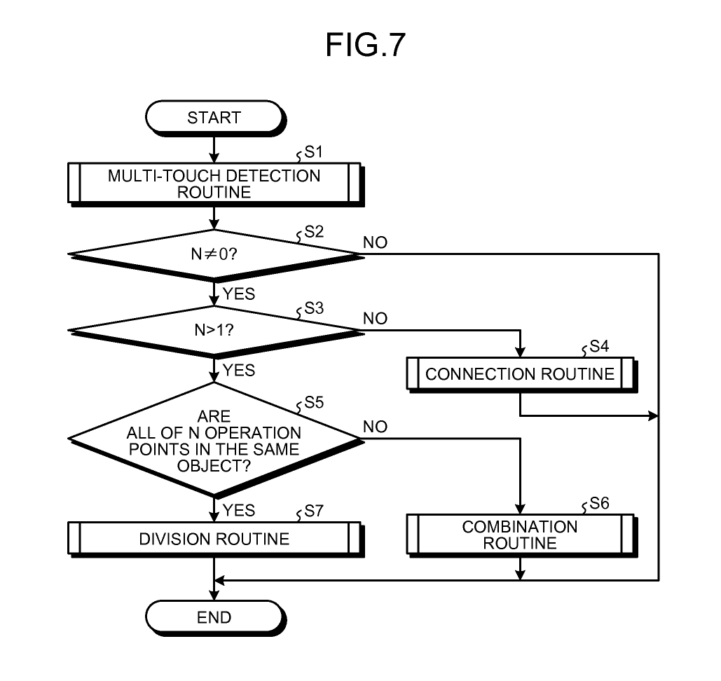

FIG. 7 is a flowchart illustrating an example of a processing procedure of the editing apparatus 100 in the embodiment. The processing illustrated in FIG. 7 is performed mainly by the object controller 13. As illustrated in FIG. 7, the object controller 13 in the embodiment performs a multi-touch detection routine (Step S1) to detect all of the operation points touched on the screen. The object controller 13 then determines whether there is one or more detected operation points on the basis of the number N of the operation points (whether N≠0 at Step S2). If no operation point is detected (No at Step S2), the object controller 13 ends the processing. If one or more operation points are detected (Yes at Step S2), the object controller 13 determines whether N is two or more (whether N>1 at Step S3). If N is one (No at Step S3), the object controller 13 performs a connection routine (Step S4) and thereafter ends the processing. If N is two or more (Yes at Step S3), the object controller 13 determines whether all of the N operation points are in the same object (Step S5). If the N operation points are not in the same object (No at Step S5), the object controller 13 performs a combination routine (Step S6) and thereafter ends the processing. If the N operation points are in the same object (Yes at Step S5), the object controller 13 performs a division routine (Step S7) and thereafter ends the processing.

Details

The details of the processing are described below.

Details of the processing performed by the object controller 13

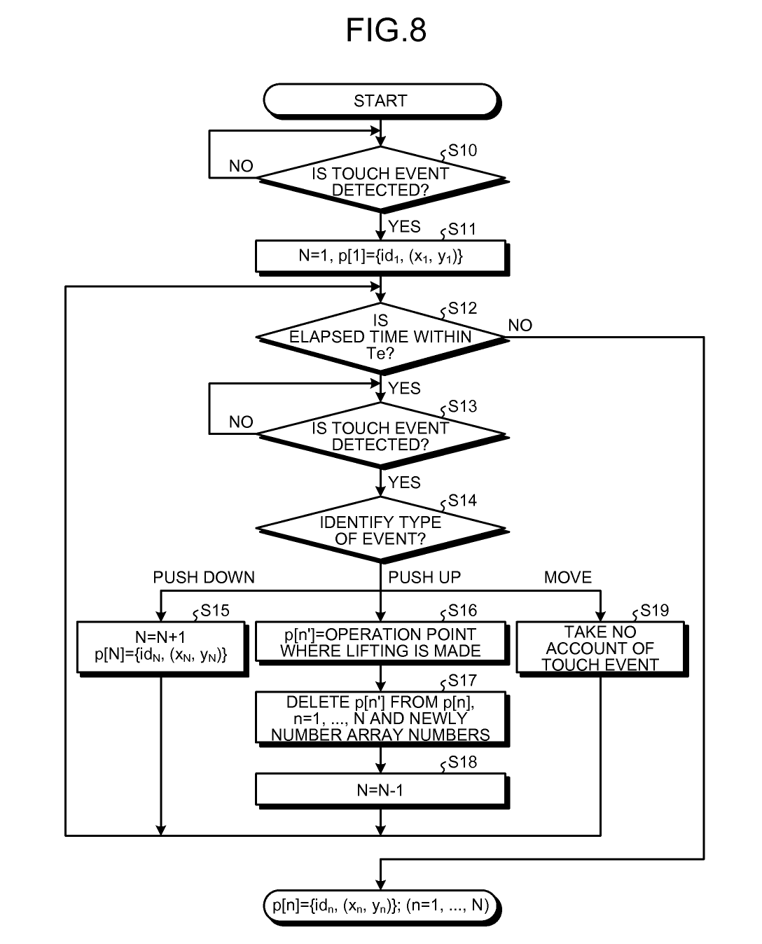

FIG. 8 is a flowchart illustrating an example of a processing procedure of the multi-touch detection routine in the embodiment. The processing illustrated in FIG. 8 is an example of the processing at Step S1 illustrated in FIG. 7. In the multi-touch detection routine in the embodiment, the detection of another touch is waited for an elapsed time Te from the time when the first operation point is touched and the operation points touched during the elapsed time Te are recorded in an array p in order to detect the one or more touched operation points.

As illustrated in FIG. 8, the object controller 13 in the embodiment first waits for the detection of the touch event (operation event) (No at Step S10). If the first touch event is detected (Yes at Step S10), the object controller 13 determines that the event is the “push down” event. The object controller 13 sets the identifier of the detected operation point as id1 and the array p[1] as {id₁, (x₁, y₁)} (Step S11) to associate the identifier of the operation point with the coordinates of the operation point. The object controller 13 then waits for the detection of the next touch event within the elapsed time Te from the detection of the first touch event (Yes at Step S12 and No at Step S13). If the next touch event is detected (Yes at Step S13), the object controller 13 identifies the type of detected touch event (Step S14). If the next touch event is not detected within the elapsed time Te (No at Step S12), the object controller 13 ends the processing.

When the type of detected touch event is the “push down” event, the object controller 13 increments N by one as the operation point touched simultaneously with the array p[1]. The object controller 13 adds the array p[N] to the array p as {id_{N}, (x_{N}, y_{N})} (Step S15). When the detected touch event is the “push up” event (a case where a finger is touched to the object for a moment and lifted from the object in a moment), the object controller 13 determines the operation point p[n′] as the operation point from which a finger is lifted (Step S16). The object controller 13 then deletes the operation point p[n′], which is the operation point from which a finger is lifted, from the array p[n] (n=1, . . . , N) and newly numbers the array numbers (Step S17) and then sets N as N−1 (Step S18). When the type of detected touch event is the “move” event, the object controller 13 regards the event as a shaking of a finger in operation and takes no account of the detected touch event (Step S19). As a result, the array p[n]={idₙ, (xₙ, yₙ)} (n=1, . . . , N), in which the detected operation points are recorded, is obtained after the completion of the multi-touch detection routine.

Connection Processing

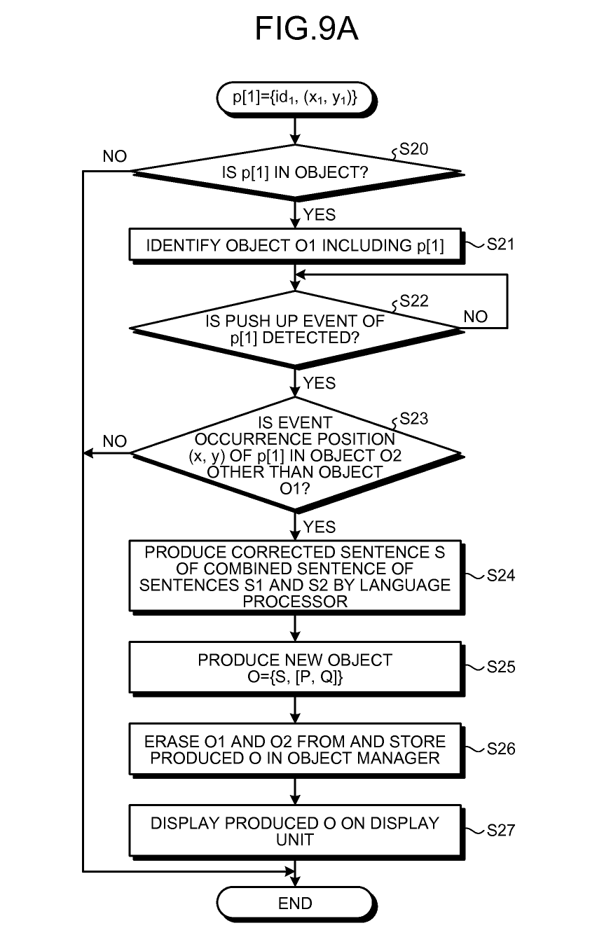

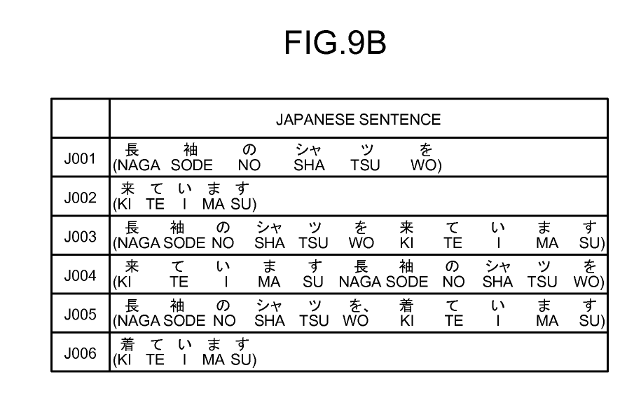

FIG. 9 is a flowchart illustrating an example of a processing procedure of the connection routine in the embodiment. The processing illustrated in FIG. 9 is an example of the processing at Step S4 illustrated in FIG. 7. In the connection routine in the embodiment, two objects are connected to each other and thus the connected object is produced, which routine is performed by the connector 131 comprised in the object controller 13 in the embodiment.

The object controller 13 in the embodiment performs the connection routine when one touched operation point is detected in the multi-touch detection routine.

As illustrated in FIG. 9, the object controller 13 receives the detected operation point p[1]={id₁, (x₁, y₁)}. The connector 131 determines whether the operation point p[1] is in (including on the borderline of) an object (Step S20).

If the operation point p[1] is not in an object (No at Step S20), the connector 131 determines that no object is designated, and then ends the connection routine.

The determination described above can be made in the following manner. The determination whether a certain point A=(ax, ay) is the point located in (including on the borderline of) an object can be made on the basis of “point P≦point A and point A≦point Q” where the coordinates of the points P and Q of an object O={S, [P, Q]} are P=(px, py) and Q=(qx, qy). The inequality of point P≦point A means that “px≦ax and py≦ay”. In other words, the inequality of point P≦point A means that “the point P is located on the upper left side of the point A on the screen”. The point P is the upper left end point of the rectangular display area of the object O while the point Q is the lower right end point of the rectangular display area. Thus, it is determined that the point A is in, or on the borderline of, the rectangle [P, Q] if “point P≦point A and point A≦point Q”. In the following description, this determination manner is referred to as an interior point determination manner.

If the operation point p[1] is in an object (Yes at Step S20), the connector 131 identifies an object O1={S1, [P1, Q1]}, which has the operation point p[1] therein (Step S21). The connector 131 determines that it is detected that the operation point p[1] is included in the object O1. The display unit 12 may change the display form such that a user can view the object O1 in the operation target state by changing a display color of the object O1 to a color different from those of the other objects on the screen in accordance with the instruction received from the object controller 13, for example.

The connector 131 then waits for the detection of the “push up” event of the operation point p[1] (No at Step S22). If the “push up” event is detected (Yes at Step S22), the connector 131 determines whether the event occurrence position (x, y), which is the coordinates from which a finger is lifted, of the operation point p[1] is in an object O2 (second target object) other than the object O1 (first target object) using the internal point determination manner for all of the objects stored in the object manager 14 other than the object O1 (Step S23). The determination is made solely on the basis of the position from which a finger is finally lifted regardless of the moving route of the finger.

If the event occurrence position (x, y) of the operation point p[1] is in the object O1 or is not in any of the objects (No at Step S23), the connector 131 ends the connection routine. If the event occurrence position (x, y) of the operation point p[1] is in the object O2={S2, [P2, Q2]} other than the object O1, (Yes at Step S23), the connector 131 connects the objects O1 and O2 to each other, and then causes the language processor 15 to produce a corrected sentence S of the sentence (connected sentence) connecting the sentences S1 and S2 (Step S24). In the connection of the sentences, the connector 131 performs the following processing.

When the object O1 is on the object O2 after the movement in the connection operation, the connector 131 connects the sentence S2 to the sentence S1. When the object O2 is on the object O1 after the movement in the connection operation, the connector 131 connects the sentence S1 to the sentence S2. As a result, a connected sentence S′ is produced. Specifically, when S1 is the sentence J001 (FIG. 9B) and S2 is the sentence J002, the sentence S′ after the connection of the sentence S2 to the sentence S1 is the sentence J003. In contrast, the sentence S′ after the connection of the sentence S1 to the sentence S2 is the sentence J004. The language processor 15 performs grammatical correction on the connected sentence S′. The language processor 15 corrects or forms the sentence S′ (connected sentence) by language processing such as correction of homonyms in Japanese, correction of a case in English, or insertion of the punctuation marks regardless of languages. The connector 131 then determines the shape of the new object O associated with the corrected sentence S. In the determination, the point P is set to either point P1 or point P2 whichever having the y coordinate smaller than that of the other (set to the point on the upper side in the screen). The connector 131 calculates the lower right end point Q from the coordinates (x, y) of the point P, the number n of characters of the corrected sentence S, the width w of the character, and the height h of the character, for example. As a result, the shape of the new object O is determined.

The connector 131 then produces the new object O={S, [P, Q]} from the corrected sentence S and the shape of the new object O associated with the corrected sentence S (Step S25). Subsequently, the connector 131 erases the objects O1 and O2 used for the connection from the object manager 14 and stores the produced new object O in the object manager 14 (Step S26). The connector 131 instructs the display unit 12 to erase the objects O1 and O2 used for the connection from the screen and display the produced new object O (Step S27).

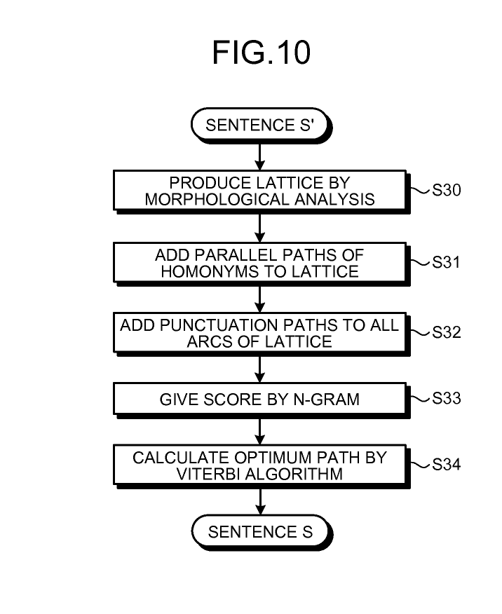

FIG. 10 is a flowchart illustrating an example of a processing procedure to produce the corrected sentence S in the embodiment. The processing illustrated in FIG. 10 is an example of the processing performed at Step S24 of the connection routine illustrated in FIG. 9. The language processor 15 in the embodiment performs grammatical correction, such as correction of characters or insertion of punctuation marks, on the sentence S. For example, when a user utters the sentence J005 (FIG. 9B) (I wear a long sleeved-shirt in English), in which a pause is given at the position of the comma, the utterance is recognized as two utterances and thus the voice recognition results are the sentence J001 and the sentence J002 (come in English). The result of the sentence J002 is wrongly recognized using the homonym because the utterance is separated into two utterances. When the two sentences are translated, the translation of them is also not appropriately done because the translation target sentences are incomplete. Conventionally, a user needs to utter the same sentence again when such false recognition occurs. The utterance, however, may be wrongly voice-recognized again or a pause may be involuntarily given in the utterance again and thus cause the false recognition. In view of such circumstances, grammatical errors such as homonyms are desired to be automatically corrected, such as the sentence J002 (come in English) is corrected to the sentence J006 (wear in English). The language processor 15 in the embodiment achieves such a correction function by performing the following processing.

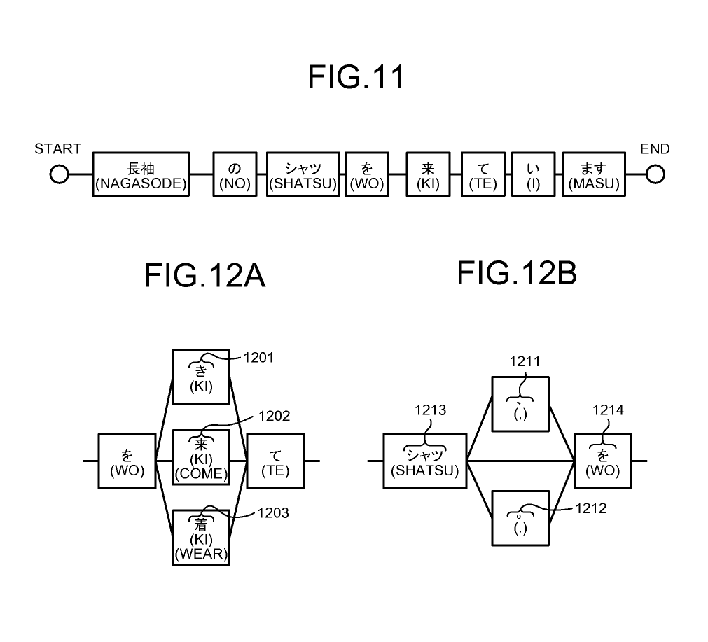

As illustrated in FIG. 10, the language processor 15 in the embodiment first receives the connected sentence S′. Subsequently, the language processor 15 performs a morphological analysis on the connected sentence S′ and produces a lattice (Step S30). FIG. 11 is a conceptual diagram of the lattice output as the result of the morphological analysis in the embodiment. FIG. 11 illustrates an example of the lattice produced when the connected sentence S′ is the sentence J003.

Referring back to FIG. 10, the language processor 15 then adds parallel paths of the homonyms to the produced lattice (Step S31). FIG. 12A is a schematic diagram illustrating an example of the addition of the paths to the lattice in the embodiment. FIG. 12A illustrates an example in which the character 1201 (hiragana) and the character 1203 (kanji which means wear in English) are added to the character 1202 (kanji which means come in English) as the homonyms.

Referring back to FIG. 10, the language processor 15 then adds punctuation paths to all of the arcs of the produced lattice (Step S32). FIG. 12B illustrates an example in which the punctuation paths of the character 1211 and the character 1212 are added to the arc between the character 1213 and the character 1214.

Referring back to FIG. 10, the language processor 15 then gives a score by N-gram to the lattice processed as described above (Step S33). The language processor 15 then calculates the score of the lattice structure by tri-gram and calculates an optimum path (path having a maximum score) from the start to the end of the connected sentence S′ by Viterbi algorithm (Step S34). The score of the path from morpheme 1, morpheme 2, and morpheme 3 by tri-gram corresponds to the probability of sequential occurrences of morpheme 1, morpheme 2, and morpheme 3. The probability is statistically obtained in advance (the punctuation marks are also regarded as the morphemes). When the probability is expressed as P (morpheme 3| morpheme 1, morpheme 2), the score of the path from the start to the end of the connected sentence S′ through morpheme 1 to morpheme N is expressed (calculated) by the following Equation (5).

score of path=Σ log P (morpheme n|morpheme n−2, morpheme n−1) (5)

where n=1, . . . , N+1. Here, morpheme −1 and 0 are both assumed to be the beginning of the sentence S′ and morpheme N+1 is assumed to be the end of the sentence S′. The language processor 15 outputs the morpheme string of the calculated optimum path as the corrected sentence S.

When the score P (the character 1203 (wear in English)| the character 1213, the character 1214) and the score P (the character 1202 (come in English)| the character 1213, the character 1214) are calculated by the language processing, the score P (the character 1203 (wear in English)| the character 1213, the character 1214) is larger (has a higher probability) than the score P (the character 1202 (come in English)| the character 1213, the character 1214). Thus, the output corrected sentence S is the sentence J005 (FIG. 9B) (I wear a long sleeved-shirt in English), in which the character 1202 (come in English) in the connected sentence S′ is corrected. In this way, correction is automatically performed in the embodiment in accordance with the language specification (context and knowledge) of that the sentence J002 (come in English) is wrong but the sentence J006 (wear in English) is correct in relation to the character 1213 (shirt in English). As a result, the embodiment enables the correcting operation such as text input to be reduced and no cumbersome editing work to be required.

The processing described above may output the corrected sentence S being the same as the connected sentence S′ as a result in some cases, which means that no correction is made. When words in different cases are added as the parallel paths, the capital letters and the small letters described in English can be corrected both in English and Japanese in the same manner as homonyms. An example of the algorithms is described above to explain that the sentence S can be corrected. The correcting manner, however, is not limited to this example. Known text correcting manners are also applicable.

Combination Processing

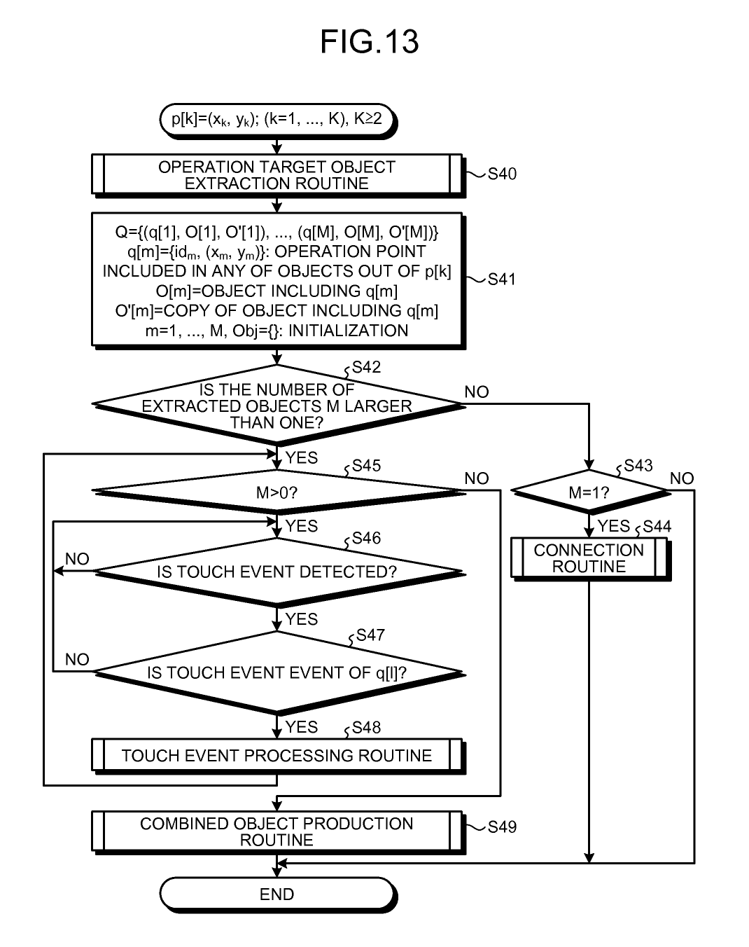

FIG. 13 is a flowchart illustrating an example of a processing procedure of the combination routine in the embodiment. The processing illustrated in FIG. 13 is an example of the processing at Step S6 illustrated in FIG. 7. In the combination routine in the embodiment, two or more objects are combined and the combined object is produced, which routine is performed by the combiner 132 comprised in the object controller 13.

The object controller 13 in the embodiment performs the combination routine when two or more (K≧2) touched operation points are detected in the multi-touch detection routine and all of the detected operation points are not in the same object.

As illustrated in FIG. 13, the object controller 13 receives the detected operation points p[k]=(xₖ, yₖ) (k=1, . . . , K). The combiner 132 first extracts objects that include therein (including the borderline thereof) the detected operation points by an operation target object extraction routine (Step S40).

As a result, the combiner 132 receives an output (a set of operation points) Q={(q[1], O[1]), . . . , (q[M], O[M])} of the operation target object extraction routine and produces copies O′[m], of the respective objects O[m] (m=1, . . . , M), and obtains Q={(q[1], O[1]), O′[1]), . . . , (q[M], O[M], O′[M])}. q[m]={idₘ, (xₘ, yₘ)} represents the operation point included in any of the objects out of p[k]. O[m] represents the object including q[m]. O′[m] represents the copy of the object including q[m]. The object O is the object touched with a finger. The object O′ is the copy to store therein the position of the object after the movement in accordance with the move of the finger. m is 1, . . . , M. The combiner 132 initializes Obj as Obj={ } (set Obj as a set having no elements) retaining one or more objects when the “push up” event is detected (a finger is lifted and the operation is complete) (Step S41).

The combiner 132 then determines whether the number of extracted objects, M, is two or more (M>1) (Step S42). If M is one (No at Step S42 and Yes at Step S43), the combiner 132 proceeds to the connection routine (Step S44) because the operation point designates one object. If M is zero (No at Step S42 and No at Step S43), the combiner 132 ends the processing. If M is two or more (Yes at Step S42), the combiner 132 detects the touch event of the operation point q[1] (Step S45 to Step S47) if no fingers are lifted from all of the operation points and touched operation points are present on the screen (Yes at Step S45, i.e., M>0). The combiner 132 then performs a touch event processing routine (Step S48). M is decremented by one at every detection of the “push up” event in the touch event processing routine.

If the fingers are lifted from all of the operation points and no touched operation points are present on the screen, which means the operation is completed (No at Step S45, i.e., M=0), the combiner 132 performs a combined object production routine (Step S49).

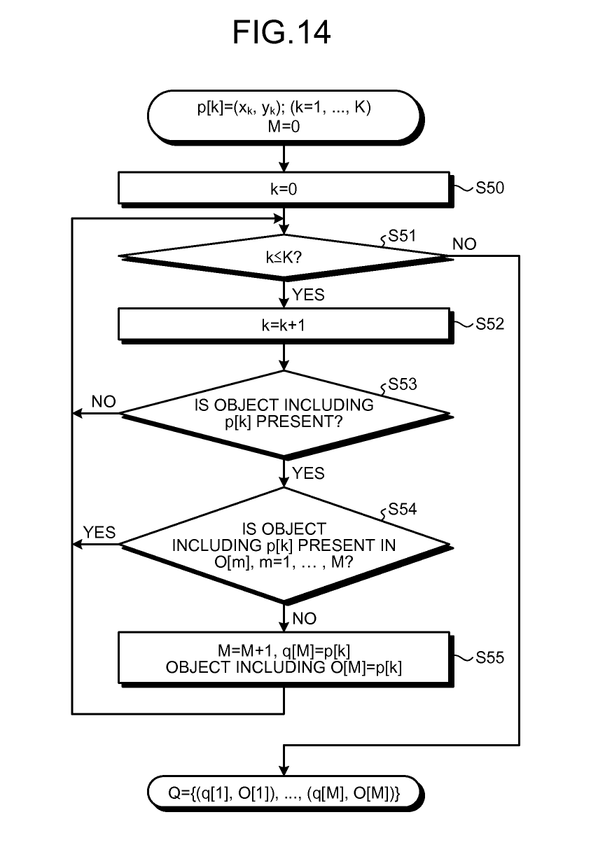

FIG. 14 is a flowchart illustrating an example of a processing procedure of the operation target object extraction routine in the embodiment. The processing illustrated in FIG. 14 is an example of the processing at Step S40 of the combination routine illustrated in FIG. 13. The operation target object extraction routine in the embodiment extracts the objects including the detected operation points.

As illustrated in FIG. 14, the combiner 132 in the embodiment receives the detected operation points p[k]=(xₖ, yₖ) (k=1, . . . , K). The combiner 132 initializes the number of extracted objects, M, (M=0). K represents the number of detected operation points. The combiner 132 determines whether the object including the operation point p[k] is present using the interior point determination manner (Step S53) for all of the detected operation points p[k] (k=1, . . . , K) (Step S50, Yes at Step S51, and Step S52). If the object including the operation point p[k] is present (Yes at Step S53), the combiner 132 determines whether the object including the operation point p[k] is present in the array O[m] (m=1, . . . , M) storing a plurality of objects saved in the object manager 14 (Step S54). If the object including the operation point p[k] is not present in the array O[m] (m=1, . . . , M), which is a group of the objects (No at Step S54), the combiner 132 adds the operation point p[k] as an array q[M], which is the (M+1)th element, recording the operation points of the extracted objects (destinations after the completion of the operation). The combiner 132 also adds the object including the operation point p[k] as the array O[M], which is the (M+1)th element. As a result, the combiner 132 extracts the operation target object. The combiner 132 then increments M by one (M+1 at Step S55). The combiner 132 processes all of the detected operation points p[k] in the manner described above and outputs Q={(q[1], O[1]), . . . , (q[M], O[M])} as the extraction result of the operation target objects.

The operation point p[k] may be the redundantly touched operation point on the same object. The operation point p[k] may designate no object. In the operation target object extraction routine, Q={(q[1], O[1]), . . . , (q[M], O[M])} is obtained such that one operating point corresponds to one object, which excludes the cases described above.

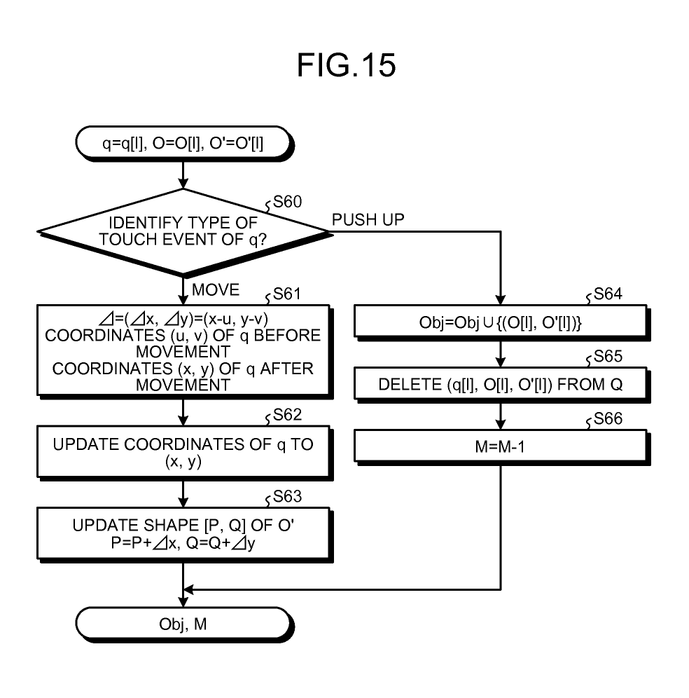

FIG. 15 is a flowchart illustrating an example of a processing procedure of the touch event processing routine in the embodiment. The processing illustrated in FIG. 15 is an example of the processing at Step S48 of the combination routine illustrated in FIG. 13. The touch event processing routine in the embodiment processes the detected touch event (operation event).

As illustrated in FIG. 15, the combiner 132 in the embodiment receives the extracted object O=O[l], the object O′=O′[l], which is the copy of the extracted object O, and q=q[l], which is the operation point of the extracted object O (destination after the completion of operation). Obj retains the current extracted objects. M is the number of current extracted objects. The combiner 132 identifies the type of touch event of the operation point q of the object O (Step S60). If the touch event of the operation point q is the “move” event, the combiner 132 calculates a moving amount of the operation point, Δ=(Δx, Δy)=(x−u, y−v), on the basis of the coordinates (u, v) of the operation point q before the movement and the coordinates (x, y) of the operation point q after the movement (Step S61). The combiner 132 then updates the coordinates of the operation point q to the coordinates (x, y) after the movement (Step S62). The combiner 132 then updates the shape [P, Q] of the object O′, which is the copy of the extracted object O, as follows: P=P+Δx and Q=Q+Δy (Step S63). As a result, the object O′, which is the copy of the extracted object O, moves in accordance with the moving amount of the operation point q. The display unit 12 may move the touched object O to and display it at the position after the movement in the updating of the “move” event. If the touch event of the operation point q is the “push up” event, the combiner 132 registers (O[l], O′[l]) to Obj on the basis of the determination that the operation on the object O is completed (Step S64). The combiner 132 then deletes (q[l], O[l], O′[l]) from Q (Step S65) and decrements M by one (Step S66). In the equation of “A=A∪{B}” illustrated in FIG. 15, ∪ represents a union, which means that an element B is registered in (added to) a set A. In the following description, such equation is used in the same manner.

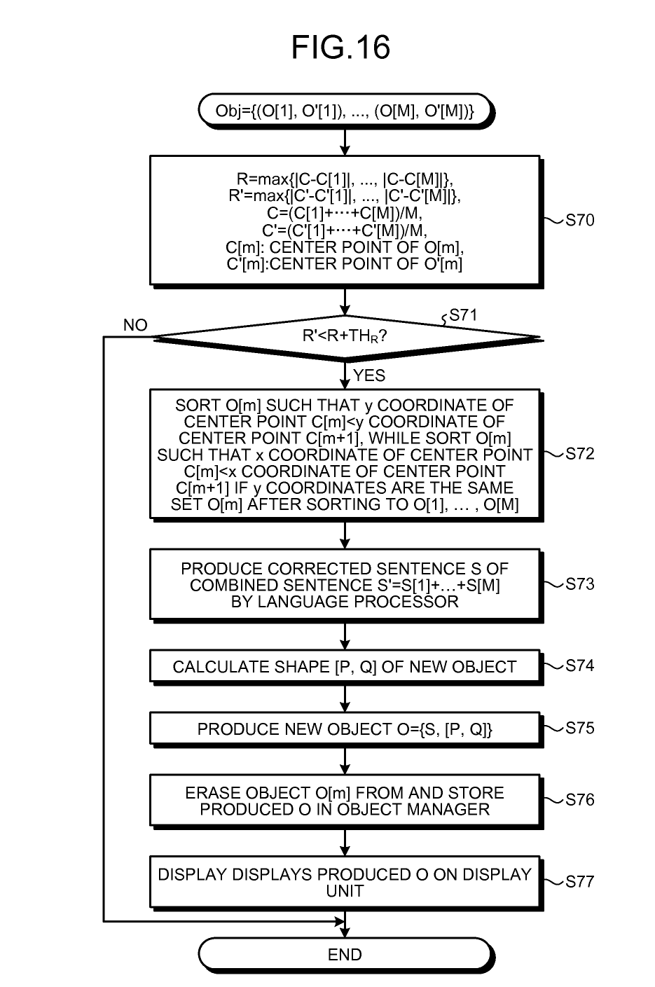

FIG. 16 is a flowchart illustrating an example of a processing procedure of the combined object production routine in the embodiment. The processing illustrated in FIG. 16 is an example of the processing at Step S49 of the combination routine illustrated in FIG. 13. The combined object production routine in the embodiment combines the extracted multiple objects and produces a new object.

As illustrated in FIG. 16, the combiner 132 in the embodiment receives Obj={(O[1], O′[1]), . . . , (O[M], O′[M])}, which retains the extracted multiple objects. M is the total number of extracted objects. The combiner 132 first sets the center points of the extracted objects O[m] as C[m] (m=1, . . . , M) and the gravity center C of C[m] as (C[1]+ . . . +C [M])/M. The combiner 132 sets a maximum R of the distances from the gravity center C to the respective objects O[m] as max {|C−C[1], . . . , C−C[M]|}. The combiner 132 sets the center points of the objects O′[m], which are the copies of the extracted objects O[m], as C′[m], and the gravity center C′ of C′[m] as (C′[1]+ . . . +C′[M])/M. The combiner 132 sets a maximum R′ of the distances from the gravity center C′ to the respective objects O′[m] as max {|C′−C′[1], . . . , C′−C′[M]|} (Step S70). The difference between R and R′, (R−R′) means that how close the extracted objects move to the gravity center before and after the operation. The smaller R′ the larger the moving amount. The combiner 132 thus determines whether a condition that the value of R′ is smaller than a value obtained by adding a certain threshold TH_{R} to the value of R is satisfied (Step S71).

If the condition is not satisfied (No at Step S71), the combiner 132 ends the processing without combining the extracted objects. The condition prevents the combination processing from being performed unless the movement equal to or larger than the certain threshold TH_{R} is detected taking into consideration a tiny movement of fingers occurring when a user touches the screen once but thereafter lifts the fingers from the screen without any change due to a change in the mind of the user, for example.

If the condition is satisfied (Yes at Step S71), the combiner 132 determines that a sufficient moving amount is detected. The combiner 132 sorts all of the extracted objects O[m] in ascending order of the y coordinates of the center points C[m] (y coordinate of C[m]<y coordinate of C[m+1]) in order to determine the combination order of the sentences S to be combined. The combiner 132 newly sets the array O[m] after the sorting as the extracted object O[m] (m=1, . . . , M) (Step S72). The extracted objects may not be always arranged vertically in line but may be arranged horizontally (the y coordinates are the same) or arranged irregularly. In order to address such cases, the combiner 132 may sort the extracted objects in ascending order of the x coordinates of the center points C[m] (x coordinate of the C[m]<x coordinate of C[m+1]) when the y coordinates are the same.

The combiner 132 then produces the combined sentence S′=S[1]+ . . . +S[M], in which the sentences S are combined sequentially from the sentence S displayed on the upper side in the screen in accordance with the sorting order. The combiner 132 causes the language processor 15 to produce the corrected sentence S of the produced combined sentence S′ (Step S73). The combiner 132 then calculates the shape [P, Q] of the new object from the corrected sentence S and the shape of the object located on the uppermost left side in the combined multiple objects (Step S74).

The combiner 132 then produces a new object O={S, [P, Q]} from the corrected sentence S and the calculated shape [P, Q] (Step S75). Subsequently, the combiner 132 erases the multiple objects O[m] used for the combination from the object manager 14 and stores the produced new object O in the object manager 14 (Step S76). The combiner 132 then instructs the display unit 12 to erase the multiple objects O[m] used for the combination from the screen and display the produced new object O (Step S77).

Division Processing

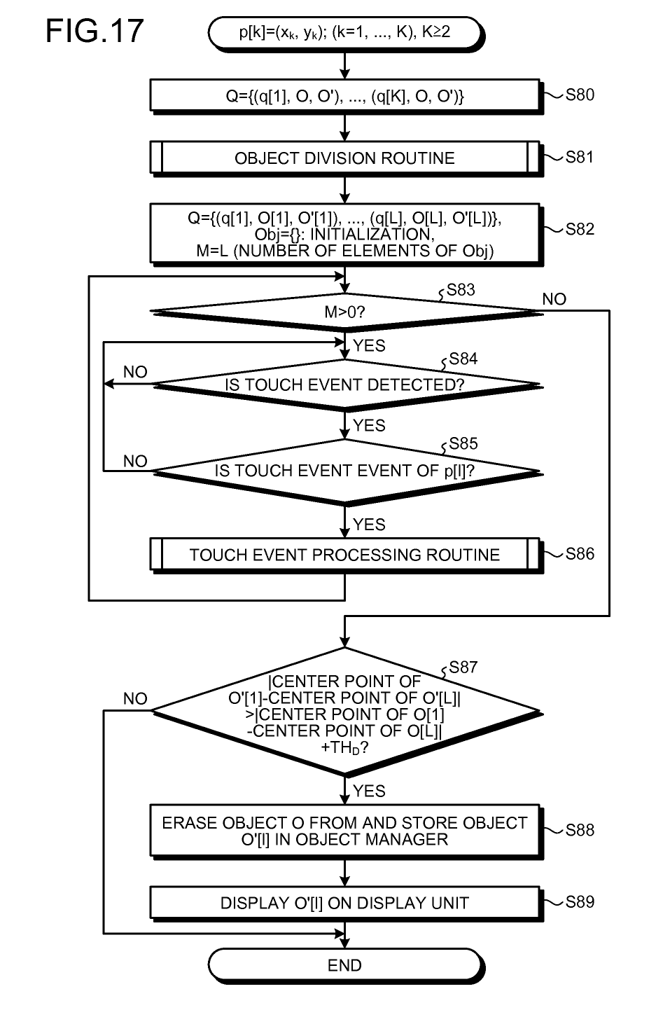

FIG. 17 is a flowchart illustrating an example of a processing procedure of the division routine in the embodiment. The processing illustrated in FIG. 17 is an example of the processing at Step S7 illustrated in FIG. 7. In the division routine in the embodiment, one object O is divided and the multiple objects are produced, which routine is performed by the divider 133 comprised in the object controller 13.

The object controller 13 in the embodiment performs the Division routine when two or more (K≧2) touched operation points are detected in the multi-touch detection routine and all of the detected operation points are in the same object O.

As illustrated in FIG. 17, the object controller 13 receives the detected operation points p[k]=(xₖ, yₖ) (k=1, . . . , K). The divider 133 first produces an object O′, which is the copy of the object O including the detected operation point p[k], in the same manner performed at Step S41 in the combination routine and sets the set Q of the operation points as Q={(q[1], O, O′), . . . , (q[K], O, O′)} (Step S80).

The divider 133 then performs an object division routine using the set Q of the operation points as the input (Step S81). As a result, the divider 133 receives the output Q={(q[1], O[1], O′[1]), . . . , (q[L], O[L], O′[L])}, in which the operation points and the divided areas are associated with each other, from the object division routine, initializes Obj retaining the divided objects as Obj={ } (set Obj as a set having no elements), and sets the number of objects, M, to L, which is the number of divisions (Step S82).

The divider 133 then determines whether M is one or more (M>0) (Step S83). If M is one or more (Yes at Step S83), the divider 133 waits for the touch event occurring at any of the operation points of the set Q, q[1], . . . , q[L] (No at Step S84 and Step S85), and if the touch event is detected (Yes at Step S84 and Step S85), performs the touch event processing routine (Step S86). As a result, Obj and M are updated by the output of the touch event processing routine.

If M is zero (No at Step S83), the divider 133 determines that all of the operation points are ended by the “push up” event and thus the operation ends. The divider 133 moves the leftmost object O[1] and the rightmost object O[L] at that time to the object O′[1] and the object O′[L], respectively, which are the respective copies of the objects O[1] and O[L]. The divider 133 determines whether a condition that the distance between the center points of O′[1] and O′[L] is larger than the distance between the center points of O[1] and O[L] by a certain distance TH_{D} or more is satisfied (Step S87).

If the condition is unsatisfied (No at Step S87), the divider 133 ends the processing. If the condition is satisfied (Yes at Step S87), the divider 133 erases the object O before the division from the object manager 14 and stores the divided objects O′[1] in the object manager 14 (Step S88). The divider 133 then instructs the display unit 12 to erase the object O before the division from the screen and display the divided objects O′[1] (Step S89). The display unit 12 may display the divided objects O′[1] in an aligned manner.

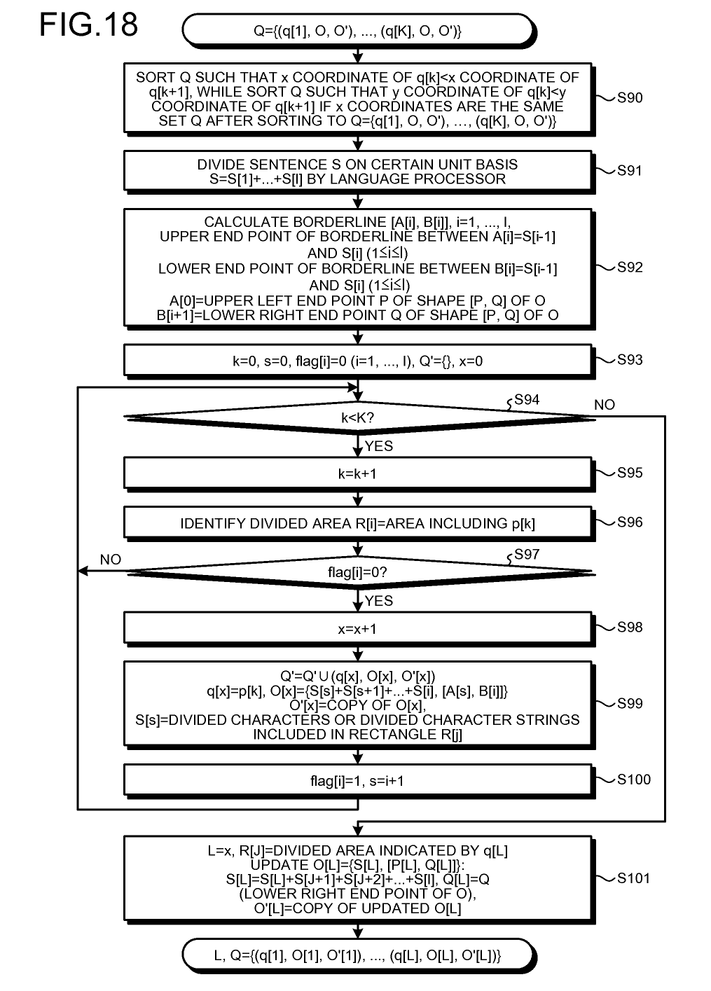

FIG. 18 is a flowchart illustrating an example of a processing procedure of the object division routine in the embodiment. The processing illustrated in FIG. 18 is an example of the processing at Step S81 of the division routine illustrated in FIG. 17. In the object division routine in the embodiment, the division positions of the object O are determined from the positions of the operating points, the designated object O is divided in accordance with the division positions, multiple new objects are produced, and the produced objects and the operation points are associated with each other.

As illustrated in FIG. 18, the divider 133 in the embodiment receives Q={(q[1], O, O′), . . . , (q[K], O, O′)}, which is the set of the operation points. K is the total number of detected operation points. The divider 133 first sorts the operation points q[k] of the set Q in ascending order of the y coordinates (y coordinate of q[k]<y coordinate of q[k+1]). The divider 133 newly sets the array Q[k] after the sorting as Q={(q[1], O, O′), . . . , (q[K], O, O′)}, which is the set of the operation points (Step S90). The divider 133 may sort the operation points q[k] of the set Q in ascending order of the x coordinates (x coordinate of q[k]<x coordinate of q[k+1]) when the y coordinates are the same.

The divider 133 then causes the language processor 15 to divide the sentence S on a certain unit basis (e.g., a “word” or a “morpheme”) and obtains the divided results S[1], . . . , S[l] sequentially from the head of the sentence (Step S91).

The divider 133 then calculates the borderlines [A[i], B[i]] (i=1, . . . , l) between the divided results S[i−1] and S[i] on the object O (Step S92). A[i] is the upper end point of the borderline between the divided results S[i−1] and S[i] (1≦i≦l) while B[i] is the lower end point of the borderline between the divided results S[i−1] and S[i] (1≦i≦l). When the border between S[i−1] and S[i] is set at the (X+1)th character from the head of the sentence (the Xth character is S[i−1] and the (X+1)th character is S[i]), the shape of the object O is [P, Q]. The respective coordinates of A[i] and B[i] are expressed (calculated) by the following Equations (6) and (7).

A[i]=(w×X,y coordinate of P) (6)

B[i]=(w×X,y coordinate of Q) (7)

where w is the width of a character and X is the number of characters from the head of the sentence to the border. In addition, as the necessary settings for the following processing, A[0] is the upper left end point P of the shape [P, Q] of the object O while B[i+1] is the lower right end point Q of the shape [P, Q] of the object O.

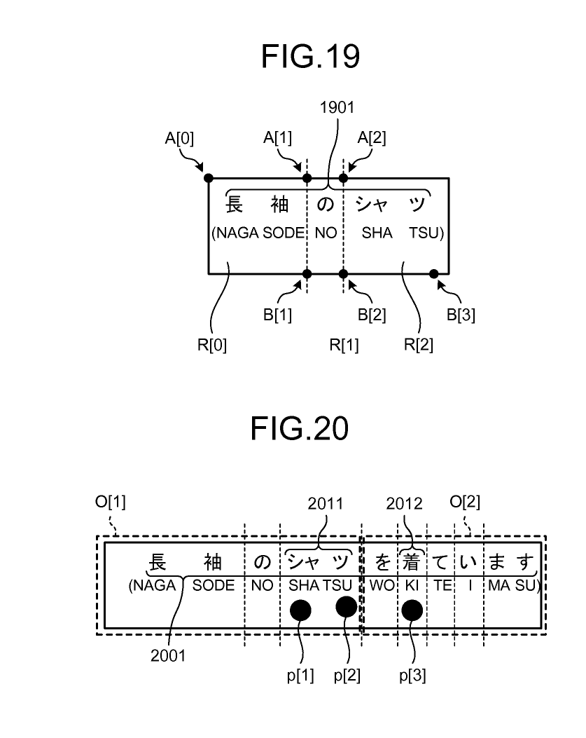

FIG. 19 is a conceptual diagram of divided areas in the embodiment. FIG. 19 exemplarily illustrates two borderlines [A[1], B[1]] and [A[2], B[2]] when the sentence 1901 is divided into three morphemes. Rectangle R[i] is defined as [A[i], B[i+1]] and corresponds to the divided area of the object O. The divided object O[i] corresponding to the divided area is expressed as O[i]={S[i], [A[i], B[i]]} (i=1, . . . , I).

Referring back to FIG. 18, the divider 133 initializes an index s of the divided area (s=0) and also initializes flag[i] (i=1, . . . , I), each of which is set to one when the divided object O includes the operation point, (flag[i]=0). The divider 133 initializes the set Q′ of the objects associated with the operation points as Q′={ } (sets Q′ as a set having no elements) and sets x (the number of elements of Q) to zero (Step S93).

The divider 133 then identifies the divided area R[i] including p[k] using the interior point determination manner (Step S96) in the order k=1, . . . , K (Step S95) with respect to all of the operation points p[k] (k=1, . . . , K) (if Yes at Step S94).

The divider 133 then determines whether flag[i] corresponding to the divided area R[i] is zero (No at Step S97), and if flag[i] is one (No at Step S97), determines that the divided area R[i] is already associated with other operation point. The divider 133 thus does not perform the association to prevent the duplicated association.

If flag[i] is zero (Yes at Step S97), the divider 133 determines that the divided area R[i] is associated with no operation point. The divider 133 increments x by one (x+1, at Step S98) and sets the divided object O[x] as the divided result {S[s]+S[s+1]+ . . . +S[i], [A[s], B[i]]}. The divider 133 registers (q[x], O[x], O′[x]) in the set Q′ of the operation points (Step S99). q[x] corresponds to operation point p[x]. O′[x] corresponds to the object that is the copy of the object O[x]. S[s] corresponds to the divided character or the divided character string included in the divided area R[i]. The divider 133 sets one to flag[i] and sets (i+1) to the index s of the divided area (Step S100).

If the processing described above is performed on all of the operation points p[k] (No at Step S94), the divider 133 sets L to the number of divisions, x, and the divided area indicated by the operation point q[L] as the divided area R[J]. The divider 133 combines the divided areas R[J+1], R[J+2], . . . , R[I], which are divided on a certain unit basis, and produces the area of the object O[L]. The divider 133 sets the sentence S[L] associated with the object O[L] as the divided result S[L]=S[J+1]+S[J+2]+ . . . +S[I] (the character string combining the divided results), which includes the results divided on a certain unit basis, and sets Q[L] as the lower right end point Q of the object O. The divider 133 sets the object O′[L] as the copy of the updated object O[L] (Step S101). As a result of the processing, the divider 133 outputs L, the number of elements of Q, and Q={(q[1], O[1], O′[1]), . . . , (q[L], O[L], O′[L])} as the divided results of the operation target object.

Through the processing, the designated object O is divided into areas of L objects O[x] (x=1, . . . , L) adjacent to each other. The smaller k, the further the operation point p[k] is located left on the screen. At the time when the processing is performed on the operation point p[k], the rightmost divided area in the divided areas designated by p[1], . . . , p[k−1] is R[s−1] (R[0] when s=0) and the divided area R[s] is on the right side of the divided area R[s−1]. When the operation point p[k] is included in the divided area R[i], the object O[x] sets the area combining the area including no operation point from the divided area R[s] to the divided area R[j−1] and the divided area R[j] as its shape. The character string (character string combining the divided results) in the area is set as the sentence S of the object O. As a result, the objects O[x] (x=1, . . . , L) are newly produced objects after the division. The area of the produced object O[x] and the area of the object O[x+1] (x=1, . . . , L−1) are adjacent to each other. The sentence S, thus, is the character string combining the divided results (S[1]+ . . . +S[L]). The divider 133 first causes the language processor 15 to divide the object O designated with the operating points on a certain unit basis and then obtains the divided characters or character strings (divided results) and the divided areas corresponding to the divided results. The divider 133 then determines the dividing positions of the object O from the positions of the operating points and produces a new plurality of objects after the division by recombining the divided results and the divided areas in accordance with the dividing positions to associate the produced objects with the operating points.

FIG. 20 is a schematic diagram illustrating an example of the division of the object O in the embodiment. As illustrated in FIG. 20, the object O associated with the sentence S of the sentence 2001 is divided into eight on a morpheme basis. Out of the three operation points p[1], p[2], and p[3], the two operation points p[1] and p[2] designate the area of the character 2011 while the operation point p[3] designates the area of the character 2012. In this case, the divider 133 determines the dividing position of the object O from the positions of the operating points and recombines the divided results and the divided areas. As a result, the divider 133 produces two objects O[1] and O[2] adjacent to each other. As a result of the processing, the divider 133 outputs L=2, and Q={(p[1], O[1], O′[1]), . . . , (p[3], O[2], O′[2])} as the output of the object division routine.

In the editing apparatus 100 in the embodiment, the object controller 13 produces one or a plurality of objects operable in editing from the input data received by the input receiver 11. In the editing apparatus 100 in the embodiment, the display unit 12 displays the produced objects and receives the gesture operation that instructs the connection or the combination of the objects, or the division of the object. In the editing apparatus 100 in the embodiment, the object controller 13 performs the editing processing of the connection or the combination of the objects designated in the operation, or the division of the object designated in the operation in accordance with the received operation and produces a new object or new objects. In the editing apparatus 100 in the embodiment, the display unit 12 displays the produced new object or new objects and updates the content of the editing screen to the content in which the editing operation is reflected.

The editing apparatus 100 in the embodiment provides an environment where the intuitive operation can be performed on input data. The editing apparatus 100 in the embodiment allows easy editing operation and automatically corrects grammatical errors in language (false recognition), thereby making it possible to reduce a burden in editing work such as the correction of false recognition. Consequently, the editing apparatus 100 in the embodiment can enhance the convenience of a user. The editing apparatus 100 in the embodiment can readily achieve an expanded function to enable operation to be performed, such as copying the sentence S of an object to another text editor, directly editing the sentence S, and storing the sentence S in a file. As a result, services having high convenience can be provided to a user.

In the embodiment, the description is made on a case where a text sentence is edited that is produced from the recognition result of an input voice. The editing function of the editing apparatus 100 is not limited to this case. The function (editing function) of the editing apparatus 100 in the embodiment is also applicable to a case where symbols and graphics are edited, for example.

First Modification

Overview

A first modification proposes processing to insert a sentence associated with an object into a sentence associated with a connected object in addition to the connection operation. The insertion operation may be performed as follows, for example. An object is divided into two objects by the division operation. Another object serving as an insert is connected to one of the divided objects and thereafter the other of the divided objects is connected to the connected object. This case, however, requires one time of the division operation and two times of the combination operation, thereby causing the operation to be cumbersome. The first modification provides an environment that enables a new object to be inserted by the same operation (the same number of times of operation) as the connection operation of two objects. As a result, the usability can be further enhanced. In the following description, items different from those of the first embodiment are described, and the same items are labeled with the same reference numerals and the duplicated descriptions thereof are omitted.

Details

Insertion-Connection Processing

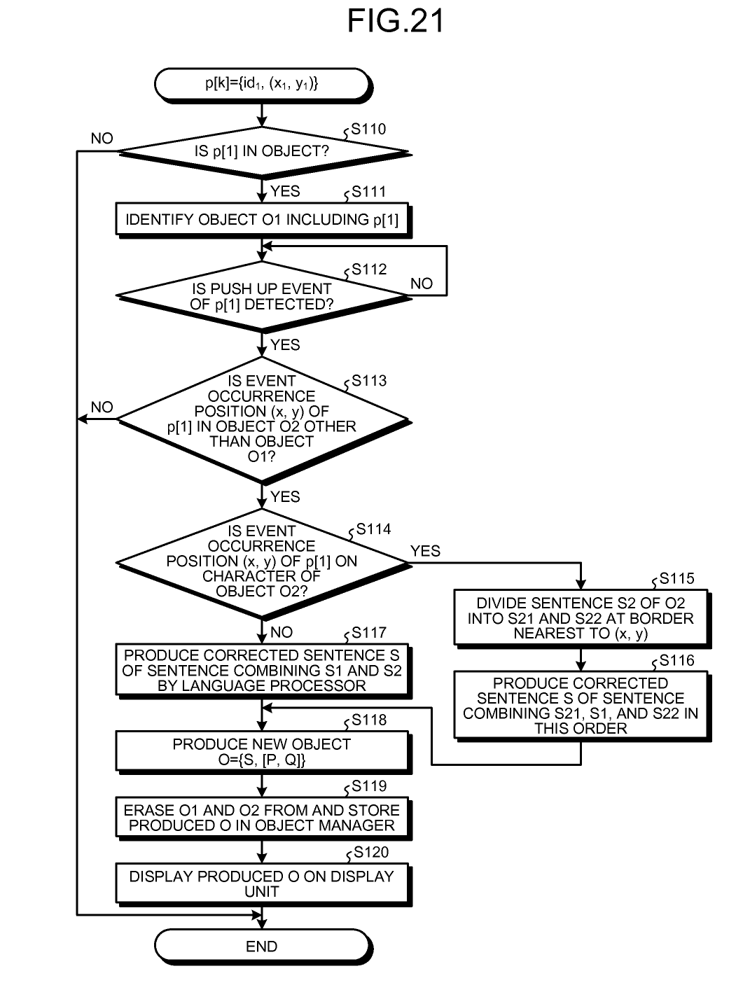

FIG. 21 is a flowchart illustrating an example of a processing procedure of an insertion-connection routine in the first modification. The processing illustrated in FIG. 21 is an example of the processing of the insertion-connection routine executable instead of the connection routine at Step S4 illustrated in FIG. 7. The insertion-connection routine in the first modification differs from the connection routine illustrated in FIG. 9 in the processing from Step S114 to Step S116.

As illustrated in FIG. 21, if the event occurrence position (x, y) of the operation point p[1] is in the object O2={S2, [P2, Q2]} other than the object O1, (Yes at Step S113), the connector 131 in the first modification determines whether the event occurrence position (x, y) of the operation point p[1] is on the character of the object O2 (Step S114). In other words, the connector 131 determines whether the position where the “push up” event occurs is on the character of the object O2 or in an area other than that of the character of the object O2.

For a specific explanation, let the coordinates of the position where the “push up” event occurs be (x, y), the shape of the object O2 be [P, Q], P=(Pₓ, P_{y}), and Q=(Qₓ, Q_{y}). In this case, the coordinates (x, y) of the event occurrence position is in the object O2 at the time when the determination processing is performed. Thus, it can be determined that the coordinates (x, y) of the event occurrence position is within a certain distance THₓ from one of the right and the left sides of the rectangle of the object O2 or is within a certain distance TH_{Y} from one of the upper and the lower sides of the rectangle if any of the following conditions 1 to 4 is satisfied.

x−Pₓ<THₓ Condition 1

Qₓ−x<THₓ Condition 2

y−P_{y}<TH_{y} Condition 3

Q_{y}−y<TH_{y} Condition 4

The connector 131 determines that the “push up” event occurs in an area other than that of the character of the object O2 if the coordinates (x, y) of the event occurrence position satisfies any of conditions 1 to 4. If the coordinates (x, y) of the event occurrence position does not satisfy conditions 1 to 4, the connector 131 determines that the “push up” event occurs on the character of the object O2.

If the occurrence position of the “push up” event is in an area other than that of the character of the object O2 (No at Step S114), the connector 131 performs the connection operation (Step S117 to Step S120).

If the occurrence position of the “push up” event is on the character of the object O2 (Yes at Step S114), the connector 131 calculates the borderlines of the object O2 (e.g., the respective borderlines when the object O2 is divided on a morpheme basis) in the same manner as the object division routine illustrated in FIG. 18. The connector 131 divides the sentence S2 of the object O2 into sentences S21 and S22 at the border nearest to the coordinates (x, y) of the event occurrence position on the basis of the calculation results of the borderlines (Step S115). As an example, let the coordinates (x, y) of the event occurrence position be in the divided area R[i]=[A[i], B[i+1]], the x coordinate of A[i] be a, and the x coordinate of B[i+1] be b. In this case, the border nearest to the coordinates (x, y) of the event occurrence position is either the borderline [A[i], B[i]] (x−a b−x) or the borderline [A[i+1], B[i+1]] (x−a>b−x). Let the sentences of the object O1 and O2 be the sentences S1 and S2, respectively. The sentence S21 corresponds to the sentence S2 located on the left side from the border nearest to the coordinates (x, y) of the event occurrence position. The sentence S22 corresponds to the sentence S2 located on the right side from the border nearest to the coordinates (x, y) of the event occurrence position. The connector 131 thus sequentially connects the sentences S21, S1, and S22 in this order and then causes the language processor 15 to produce the corrected sentence S of the connected sentence S′ (Step S116). Thereafter, the connector 131 proceeds to the processing at Step S118 to continue the connection processing.

When a user wants to insert the sentence S, the user touches the object O1 that the user wants to insert with a finger, moves the finger onto the character of the object O2, and lifts the finger at an insertion position on the character. As a result, the sentence S of the designated object O1 is inserted at the position. When the finger is not lifted on the character, but near the borderline of the object O2, the sentence S is connected to the sentence S2 associated with the object O2.

As described above, the first modification provides the environment that enables a new object O to be inserted by the processing of the insertion-connection routine in the same operation (the same number of times of operation) as the connection operation of the objects O1 and O2. As a result, the first modification can further enhance the convenience of a user.

Second Modification

Overview

In the first embodiment, text is displayed in the horizontal direction from left to right. Some languages, such as Japanese, can be written horizontally and also vertically. Some languages, such as Arabic, are written horizontally from right to left. In Arabic, however, numbers are written from left to right. In this way, the writing directions, i.e., reading directions (displaying directions) vary depending on languages and contents of text. A second modification proposes processing to determine a combining order of sentences in accordance with languages, writing directions (written vertically or horizontally) of characters, or contents of text when the objects are combined (including connected). As a result, the usability can be further enhanced. In the following description, items different from those of the first embodiment are described, and the same items are labeled with the same reference numerals and the duplicated descriptions thereof are omitted.

Details

Connection Processing

In the second modification, two types of processing are described that determine the connecting order of two objects in accordance with the languages, the writing directions, and the contents. Specifically, one is the processing for the languages having a writing feature such as that of Arabic and the other is the processing for the languages having a writing feature such as that of Japanese. In the following processing, a rule (regulation) that determines the connecting order of the sentences S associated with the respective objects in accordance with the languages, the writing directions, and the contents is preliminarily defined in the language processor 15.

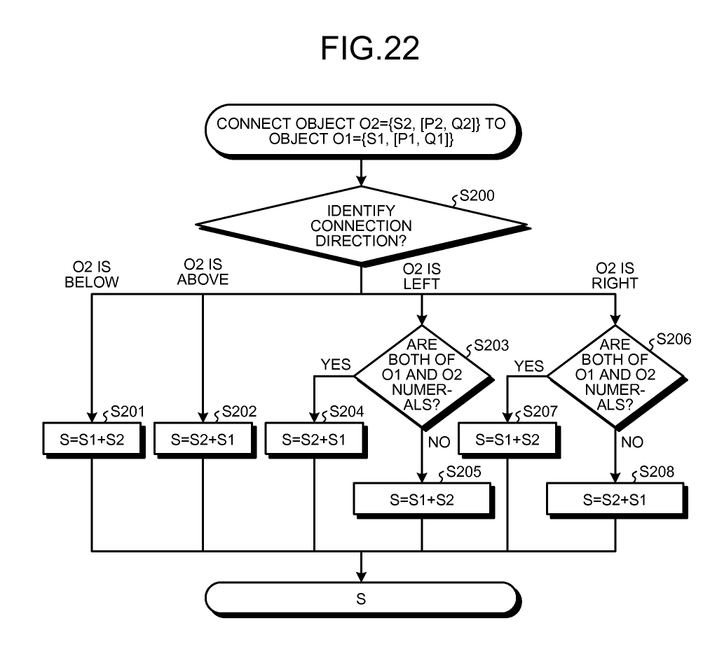

FIG. 22 is a flowchart illustrating a first example of a procedure of processing to determine the connecting order of two objects in the second modification. The processing illustrated in FIG. 22 is exemplary processing applied to the processing at Step S24 in the connection routine illustrated in FIG. 9 and to the processing at Step S116 and Step S117 in the insertion-connection routine illustrated in FIG. 21, and corresponds to the processing for the languages having a writing feature such as that of Arabic. The connector 131 in the second modification determines the connecting order in accordance with the rule defined in the language processor 15, connects the objects, and produces a new object.

As illustrated in FIG. 22, the connector 131 in the embodiment connects the object O2={S2, [P2, Q2]} to the object O1={S1, [P1, Q1]}. The connector 131 identifies a connection direction of the object O2 (connecting object) with respect to the object O1 (connected object) (Step S200).

The connector 131 connects the sentence S1 associated with the object O1 and the sentence S2 associated with the object O2 in the connecting order determined by the rule defined in the language processor 15 on the basis of the identification result of the connection direction of the object O2 with respect to the object O1.

Specifically, the connector 131 connects the sentence S2 associated with the object O2 to the sentence S1 associated with the object O1 (S=S1+S2) when the object O2 is below the object O1 in the connection direction (Step S201). The connector 131 connects the sentence S1 associated with the object O1 to the sentence S2 associated with the object O2 (S=S2+S1) when the object O2 is above the object O1 in the connection direction (Step S202). In this way, the connector 131 determines the connecting order such that the sentence S associated with the object located above the other sentence becomes the head of the sentence when the connection direction is upward or downward.

When the object O2 is on the left side of the object O1 in the connection direction, the connector 131 determines whether both of the objects O1 and O2 are numerals (Step S203). If both of the objects O1 and O2 are numerals (Yes at Step S203), the connector 131 connects the sentence S1 associated with the object O1 to the sentence S2 associated with the object O2 (S=S2+S1) (Step S204). In this way, the connector 131 determines the connecting order such that the sentence S on the left side is located on the right side of the other sentence when the connection direction is left and both of the objects are numerals. If either the objects O1 or O2 is not a numeral (No at Step S203), the connector 131 connects the sentence S2 associated with the object O2 to the sentence S1 associated with the object O1 (S=S1+S2) (Step S205). In this way, the connector 131 determines the connecting order such that the sentence S on the left side is located on the left side of the other sentence when the connection direction is left and either one of the objects is a numeral.

When the object O2 is on the right side of the object O1 in the connection direction, the connector 131 determines whether both of the objects O1 and O2 are numerals (Step S206). If both of the objects O1 and O2 are numerals (Yes at Step S206), the connector 131 connects the sentence S2 associated with the object O2 to the sentence S1 associated with the object O1 (S=S1+S2) (Step S207). In this way, the connector 131 determines the connecting order such that the sentence S on the right side is located on the left side of the other sentence when the connection direction is right and both of the objects are numerals. If either the objects O1 or O2 is not a numeral (No at Step S206), the connector 131 connects the sentence S1 associated with the object O1 to the sentence S2 associated with the object O2 (S=S2+S1) (Step S208). In this way, the connector 131 determines the connecting order such that the sentence S on the right side is located on the right side of the other sentence when the connection direction is right and either one of the objects is a numeral.

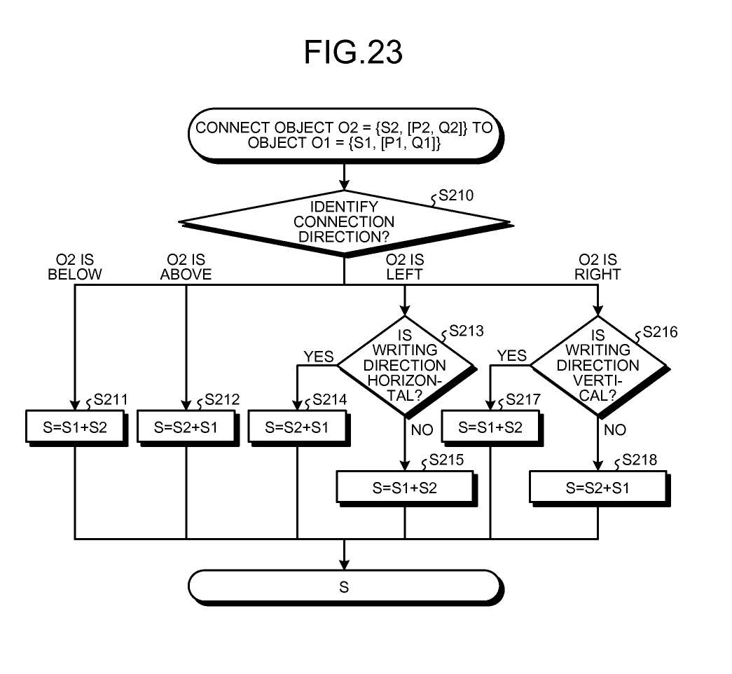

FIG. 23 is a flowchart illustrating a second example of the procedure of processing to determine the connecting order of two objects in the second modification. The processing illustrated in FIG. 23 is exemplary processing applied to the processing at Step S24 in the connection routine illustrated in FIG. 9 and to the processing at Step S116 and Step S117 in the insertion-connection routine illustrated in FIG. 21, and corresponds to the processing for the languages having a writing feature such as that of Japanese. The processing illustrated in FIG. 23 differs from that of FIG. 22 in that a determination is made on whether the writing direction is horizontal or vertical. Specifically, horizontal writing determination processing is performed instead of the numeral determination processing at Step S203 of FIG. 22 while vertical writing determination processing is performed instead of the numeral determination processing at Step S206 of FIG. 22.

As illustrated in FIG. 23, the connector 131 in the embodiment determines whether the writing direction is horizontal when the object O2 is on the left side of the object O1 in the connection direction (Step S213). If the writing direction is horizontal (Yes at Step S213), the connector 131 connects the sentence S1 associated with the object O1 to the sentence S2 associated with the object O2 (S=S2+S1) (Step S214). In this way, the connector 131 determines the connecting order such that the sentence S on the left side is located on the right side of the other sentence when the connection direction is left and the writing direction is horizontal. If the writing direction is not horizontal (No at Step S213), the connector 131 connects the sentence S2 associated with the object O2 to the sentence S1 associated with the object O1 (S=S1+S2) (Step S215). In this way, the connector 131 determines the connecting order such that the sentence S on the left side is located on the left side of the other sentence when the connection direction is left and the writing direction is not horizontal.

When the object O2 is on the right side of the object O1 in the connection direction, the connector 131 determines whether the writing direction is vertical (Step S216). If the writing direction is vertical (Yes at Step S216), the connector 131 connects the sentence S2 associated with the object O2 to the sentence S1 associated with the object O1 (S=S1+S2) (Step S217). In this way, the connector 131 determines the connecting order such that the sentence S on the right side is located on the left side of the other sentence when the connection direction is right and the writing direction is vertical. If the writing direction is not vertical (No at Step S216), the connector 131 connects the sentence S1 associated with the object O1 to the sentence S2 associated with the object O2 (S=S2+S1) (Step S218). In this way, the connector 131 determines the connecting order such that the sentence S on the right side is located on the right side of the other sentence when the connection direction is right and the writing direction is not vertical.

The identification of the connecting direction is made in the following manner. The connector 131 calculates using the following Equations (8) to (10) where the coordinates of the object O1 are (x₁, y₁) and the coordinates of the object O2 are (x₂, y₂) when the “push up” event is detected in the connection routine illustrated in FIG. 9.

D=[(x₁−x₂)²+(y₁−y₂)²]^{1/2} (8)

cos θ=(x₁−x₂)/D (9)

sin θ=(y₁−y₂)/D (10)

Because of the coordinate system in which the positive direction of the x-axis is the right direction in the screen while the positive direction of the y-axis is the downward direction in the screen, the connector 131 determines that the connection direction is upward when the following condition is satisfied: |sin θ|≦THₕ and cos θ>THᵥ. The connector 131 determines that the connection direction is downward when the following condition is satisfied: |sin θ|≦THₕ and cos θ>THᵥ. The connector 131 determines that the connection direction is left when the following condition is satisfied: |cos θ|≦THᵥ and sin θ<−THₕ. The connector 131 determines that the connection direction is right when the following condition is satisfied: |cos θ|≦THᵥ and sin θ>THₕ. THₕ and THᵥ are predetermined thresholds.

Combination Processing

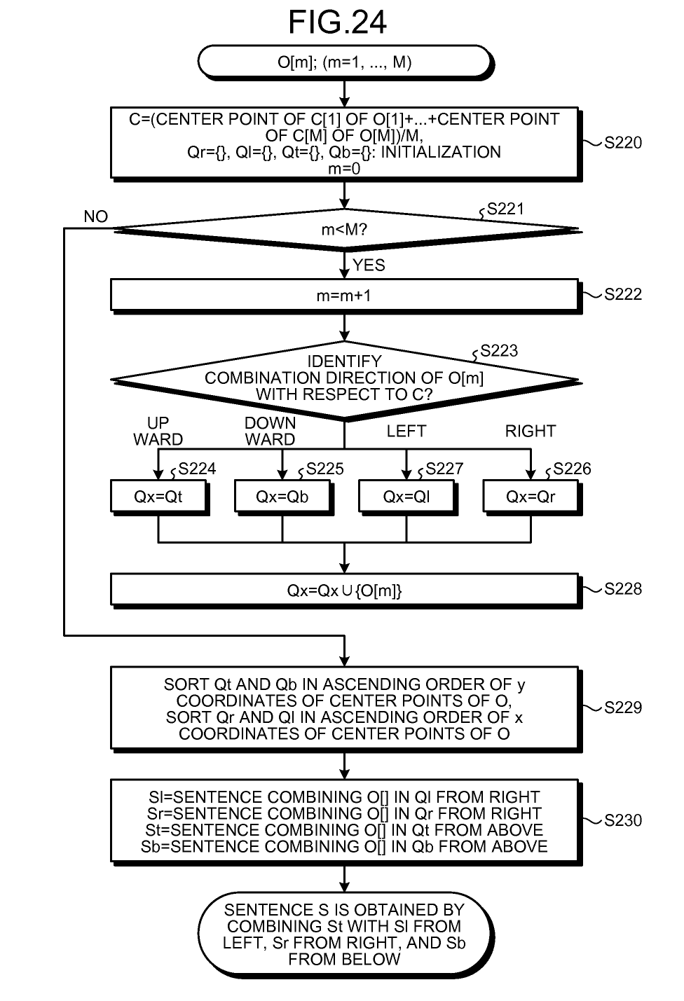

FIG. 24 is a flowchart illustrating an example of the procedure of processing to determine the combining order of three objects in the second modification. The processing illustrated in FIG. 24 is an exemplary processing applied to the processing at Step S73 in the combined object production routine illustrated in FIG. 16, and corresponds to the processing to combine two or more objects. The combiner 132 in the second modification determines the combining order in accordance with the rule defined in the language processor 15, combines the objects, and produces a new object.

As illustrated in FIG. 24, the combiner 132 in the embodiment receives the objects O[m] (m=1, . . . , M) extracted by the operation target object extraction routine. The combiner 132 calculates the gravity center C of the M objects to be combined as follows: C=(the center point C[1] of O[1]+ . . . +the center point C[M] of O[M])/M). The combiner 132 initializes the arrays Qt, Qb, Ql, and Qr as Qt, Qb, Ql, Qr={ }(sets each having no elements), which retain the identified objects O[m] for respective combination directions, i.e., upward, downward, left, and right, and sets zero to m (Step S220).

The combiner 132 identifies the combination directions of the respective objects O[m] with respect to the calculated gravity center C about all of the extracted objects O[m] (Yes at Step S221, and Step S222 and Step S223). The combiner 132 identifies the combination directions in the same manner as the connection direction in the connection routine.

The combiner 132 registers the identified objects O[m] in the respective corresponding arrays Qt, Qb, Ql, and Qr on the basis of the identification results of the combination directions (Step S224 to Step S228). Specifically, the combiner 132 registers in the array Qt the object O[m] determined that the combination direction of which is upward. The combiner 132 registers in the array Qb the object O[m] determined that the combination direction of which is downward. The combiner 132 registers in the array Ql the object O[m] determined that the combination direction of which is left. The combiner 132 registers in the array Qr the object O[m] determined that the combination direction of which is right. The objects O[m] are registered in the arrays Qt, Qb, Ql, and Qr using an array Qx as a buffer.

If the determination processing of the combination direction is made on all of the extracted objects O[m] (No at Step S221), the combiner 132 sorts all of the objects in the arrays Qt and Qb in ascending order of the y coordinates of the center points. The combiner 132 sorts all of the objects in the arrays Ql and Qr in ascending order of the x coordinates of the center points (Step S229).

If Qt={O[1], . . . , O[n]} after the sorting, the y coordinate of Qt[1]≦, . . . , the y coordinate of Qt[n]. Thus, the “sentence obtained by combining the object O[2] with the object O[1] from above” corresponds to a sentence St obtained by combining the sentence S[2] associated with the object O[2] with the sentence S[1] associated with the object O[1] by applying the combining order when the object O[2] is combined from above on the basis of the identification result of the combination direction of the objects O[1] and O[2], which are to be combined. The “sentence obtained by combining the objects O[n] of the array Qt from above” corresponds to the sentence obtained by combining the object O[2] with the object O[1] from above and continuing to combine the respective objects in the same manner up to the object O[n]. The combiner 132 produces the sentence St by combining all of the objects after the sorting in the array Qt from above and a sentence Sb by combining all of the objects after the sorting in the array Qb from above. The combiner 132 also produces a sentence Sl by combining all of the objects after the sorting in the array Ql from right and a sentence Sr by combining all of the objects after the sorting in the array Qr from right (Step S230). Finally, the combiner 132 combines the sentence St with the sentence Sl from left, the sentence Sr from right, the sentence Sb from below, and outputs the combined sentence as the sentence S combining M objects.

Other combining orders to combine the objects may be applicable. In such cases, it is premised that an object further has another attribute indicating a time of production thereof besides the sentence S and the shape [P, Q]. For example, the combiner 132 may combine the sentences S associated with the respective objects in accordance with a rule that specifies the combination such that the sentence S associated with the object O having the production time earlier than those of the other objects is further on the head side of the sentence than the other sentences S associate with the respective other objects. As a result, in a language read from right to left, for example, the sentence S associated with the object O having the earlier production time is located on the right side after the combination.

The second modification provides the environment that identifies the combination direction (including the connection direction), determines the combining order (including the connecting order) in accordance with the language, the writing direction, and the content on the basis of the identification result, and combines the multiple objects in the determined combination order. As a result, the second modification can further enhance the convenience of a user.

### Second Embodiment

A second embodiment proposes processing to produce an action object for an object. The action object corresponds to an object dynamically produced for an object operable in editing, for example. The action object has an attribute having a value of data producible from the sentence associated with the object serving as the production source of the action object. The action object is not always required to be displayed on the screen, and thus may not need to have the shape attribute. The action object is processed in synchronization with the object serving as the production source of the action object. The action object has such characteristics.

Overview

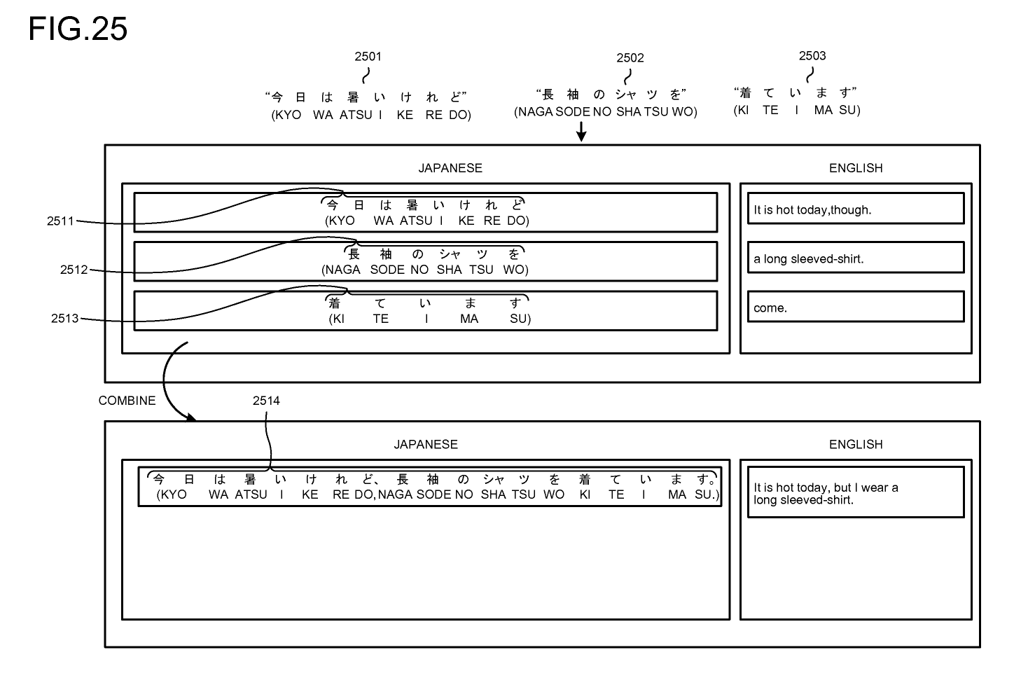

FIG. 25 is a schematic diagram illustrating an example of provision of a translation service. As illustrated in FIG. 25, a voice input is transcribed into text and a translation result is produced in a translation service based on voice input, for example. In such a translation service, the input voice is displayed as text on the right side of the screen for each utterance while the translation result is displayed on the left side of the screen. In this case, the attribute of the action object corresponds to the translated sentence of the object O produced from the voice input (input data).

The following describes an example when a user uses a translation service translating Japanese into English. The user utters the sentence 2501, the sentence 2502, and the sentence 2503 (which means that it is hot today, but I wear a long sleeved shirt in English) with pauses between utterances to input the voice. As a result, the translation service displays the sentence 2511, the sentence 2512, and the sentence 2513 (which means come in English) in Japanese, and “it is hot today, though”, “a long-sleeved shirt”, and “come” in English as the translated results of the respective sentences. The translated result using such a manner is highly likely to include wrong translations or does not make sense as a sentence although the translated words are correct, when the original sentence is incomplete.

In the embodiment, the three divided objects corresponding to the sentence 2511, the sentence 2512, and the sentence 2513 are combined and a corrected new object corresponding to the sentence 2514 (which means that it is hot today, but I wear a long sleeved-shirt in English) is produced. In the embodiment, an action object corresponding to the new object is produced. Specifically, an action object is produced that has an attribute of “it is hot today, but I wear a long-sleeved shirt”, which is the translated result of the sentence 2514.

The editing apparatus in the embodiment produces the objects each serve as an editing operation unit from the input data, edits the produced objects in accordance with the gesture operation received through the display screen, and furthermore processes the action objects in synchronization with the editing operation of the objects serving as the production sources of the action objects.

The editing apparatus in the embodiment thus can achieve the intuitive operation on the input data, thereby making it easy to perform the editing operation. As a result, a burden in editing work such as the correction of false recognition can be reduced. Consequently, the editing apparatus in the embodiment can enhance the convenience of a user.

The following describes a structure and operation of the function of the editing apparatus in the embodiment. The following description is made on a case where a text sentence is edited that is produced from the recognition result of an input voice and then the text sentence is translated. In the following description, items different from those of the first embodiment are described, and the same items are labeled with the same reference numerals and the duplicated descriptions thereof are omitted.

Structure

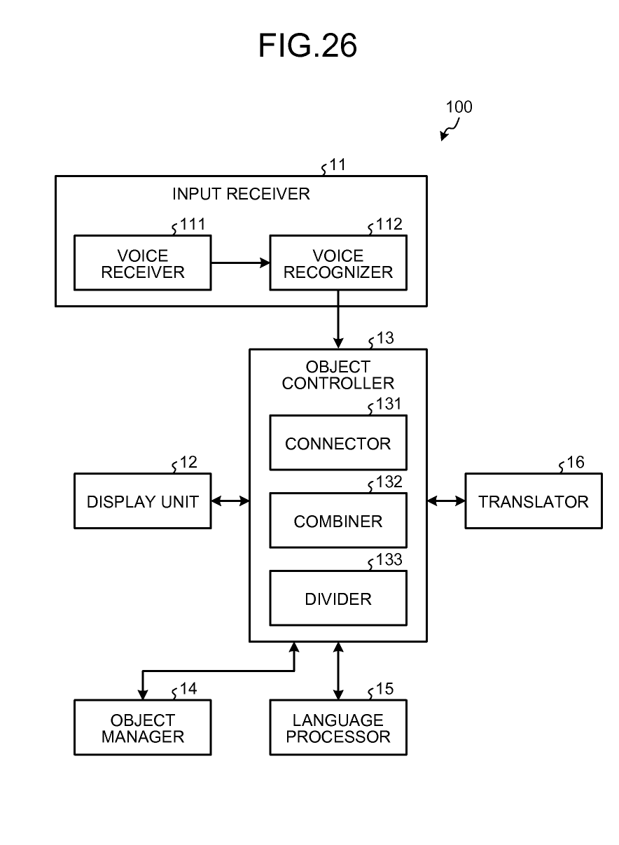

FIG. 26 is a schematic diagram illustrating a functional structure of the editing apparatus 100 in the embodiment. As illustrated in FIG. 26, the editing apparatus 100 in the embodiment comprises a translator 16 that translates original sentences in addition to the respective functional modules described in the first embodiment. The translator 16 translates the sentence S associated with the object O edited by the object controller 13 into a designated language and passes the translated result to the object controller 13. When receiving the translated result, the object controller 13 produces an action object corresponding to the object O on the basis of the translated result. The object controller 13 produces the action object having an attribute, a value of which is the translated result received from the translator 16. The action object thus produced is managed by the object manager 14 in association with the object O serving as the production source of the action object.

The following describes processing of the editing operation performed by the editing apparatus 100 in the embodiment.

Processing

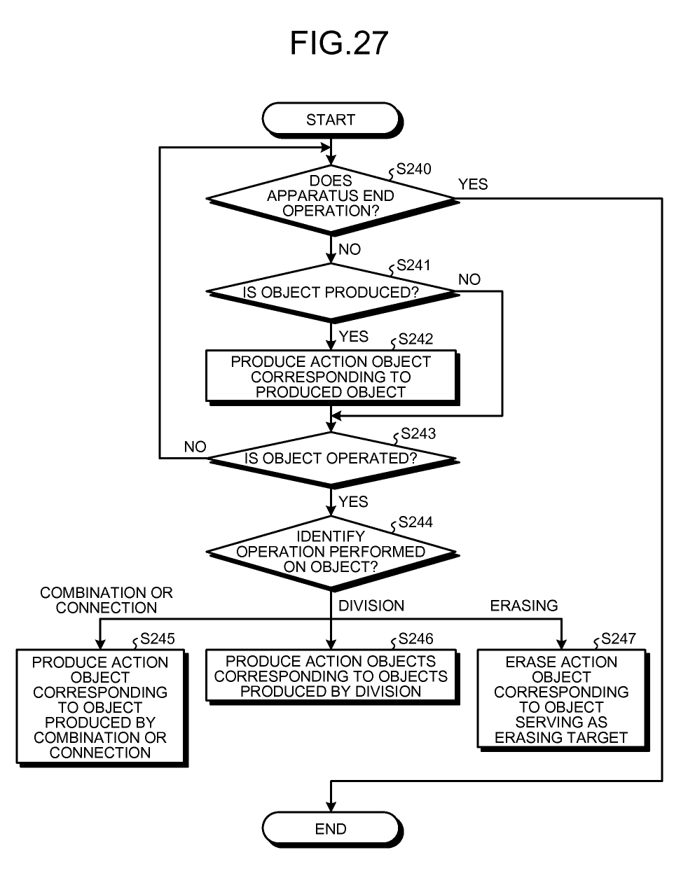

FIG. 27 is a flowchart illustrating an example of a processing procedure of the editing apparatus 100 in the embodiment. The processing illustrated in FIG. 27 is performed mainly by the object controller 13. The editing apparatus 100 in the embodiment enables erasing operation of the objects in addition to the various types of editing operation such as the connection or the combination of the objects, or the division of the object. As illustrated in FIG. 27, the editing apparatus 100 in the embodiment performs the following processing using the object controller 13 (No at Step S240) until the apparatus ends the operation such as the power-off of the apparatus.

The object controller 13 in the embodiment first produces an object from the input data (Yes at Step S241) and then produces the action object corresponding to the produced object (Step S242). The object controller 13 stores the produced action object in the object manager 14 in association with the object serving as the production source of the action object. The display unit 12 may update the display on the screen at this time. In addition, software (application) providing the service may perform certain processing caused by the production of the action object. If no object is produced from the input data (No at Step S241), the object controller 13 skips the processing at Step S242.

The object controller 13 then determines whether the editing operation is performed on the object (Step S243). If the operation is performed on the object (Yes at Step S243), the object controller 13 identifies the editing operation performed on the object (Step S244). If no editing operation is performed on the object (No at Step S243), the object controller 13 proceeds to the processing at Step S240.

As a result of the identification at Step S244, if the received editing operation is the connection operation or the combination operation, the object controller 13 produces a new action object with respect to the object produced by being connected or combined (action object corresponding to the connected or the combined object). The produced action object has an attribute of data producible from the sentence S of the connected or the combined object (Step S245).

As a result of the identification at Step S244, if the received editing operation is the division operation, the object controller 13 produces new action objects with respect to the objects produced by being divided (action objects corresponding to the divided objects). The action objects each have an attribute of data producible from the sentence S of the divided object (Step S246).

As a result of the identification at Step S244, if the received editing operation is the erasing operation, the object controller 13 erases the action object corresponding to the object serving as the target of erasing (Step S247). The object controller 13 erases the action object together with the corresponding object from the object manager 14. The display unit 12 may update the display on the screen at this time. In addition, the software (application) providing the service may perform certain processing caused by the erasing of the action object.

In the editing apparatus 100 in the embodiment, the object controller 13 produces one or a plurality of objects operable in editing from the input data received by the input receiver 11. In the editing apparatus 100 in the embodiment, the display unit 12 displays the produced objects and receives the gesture operation that instructs the connection or the combination of the objects, or the division of the object. In the editing apparatus 100 in the embodiment, the object controller 13 performs the editing processing of the connection or the combination of the objects designated in the operation, or the division of the object designated in the operation in accordance with the received operation and produces a new object or new objects. The object controller 13 produces the action objects having attributes of data producible from the objects on which the editing processing of the connection, the combination, or the division is performed. In the editing apparatus 100 in the embodiment, the display unit 12 displays the produced new object or new objects and updates the content of the editing screen to the content in which the editing operation is reflected.

The editing apparatus 100 in the embodiment provides the environment where the intuitive operation can be performed on input data and processes the produced action objects in synchronization with the editing processing of the objects serving as the production sources of the action objects. The editing apparatus 100 in the embodiment allows easy editing operation in various services such as translation services and automatically corrects grammatical errors in language (false recognition), thereby making it possible to reduce a burden in editing work such as the correction of false recognition. Consequently, the editing apparatus 100 in the embodiment can enhance the convenience of a user.

In the embodiment, the description is made on a case where a text sentence is edited that is produced from the recognition result of an input voice and then the text sentence is translated. The editing function of the editing apparatus 100 is not limited to this case. The function (editing function) of the editing apparatus 100 in the embodiment is also applicable to editing in a service that manages the order histories of products, for example.

Third Modification

A third modification describes a case where the editing apparatus 100 in the second embodiment is applied to a service that manages the order histories of products (hereinafter referred to as the “product management service”). In the following description, items different from those of the second embodiment are described, and the same items are labeled with the same reference numerals and the duplicated descriptions thereof are omitted.

Overview

In the example of the third modification, the object controller 13 produces an action object having attributes of names of ordered products and the number of ordered products from the object O of the received order, for example. The action object also has a production time of the action object as the attribute to control the order history of the product.

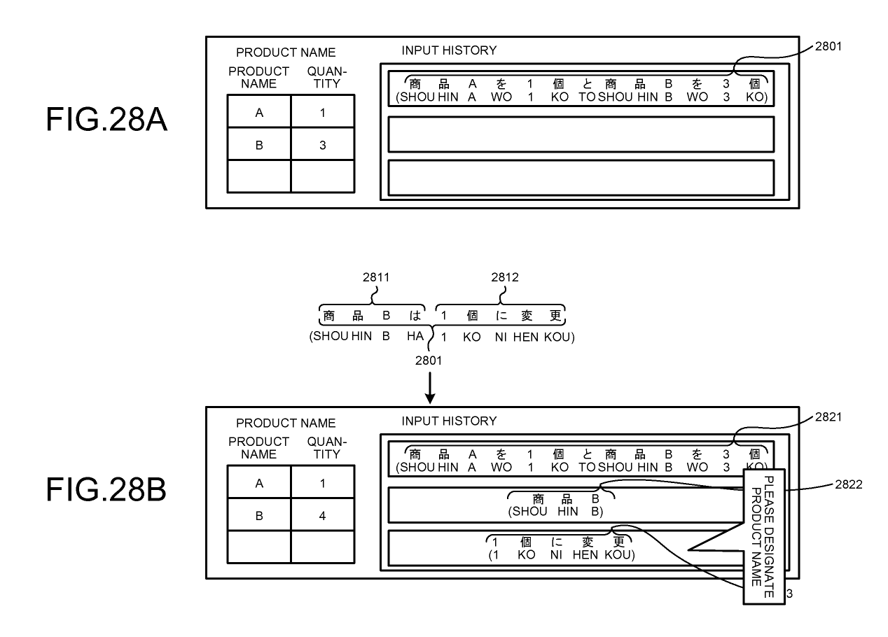

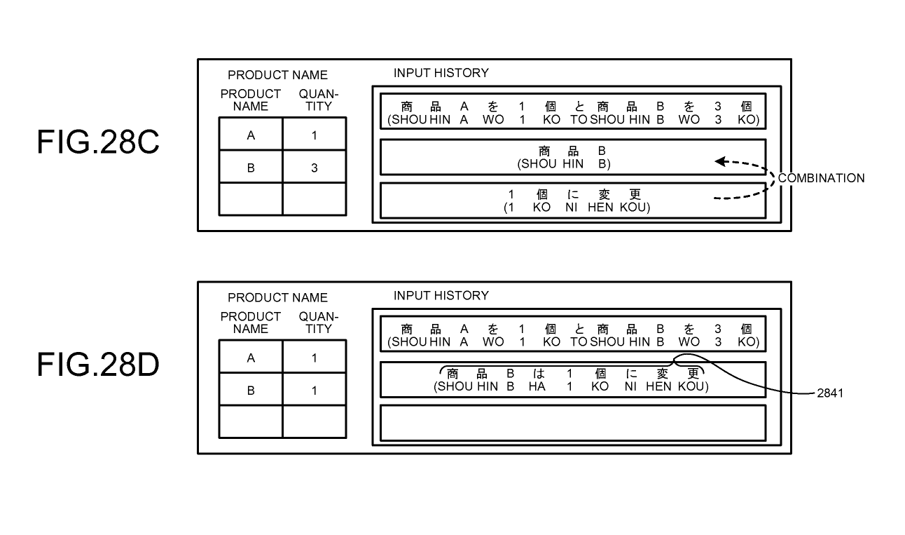

FIGS. 28A to 28D are schematic diagrams illustrating examples of provision of the product management service. As illustrated in FIG. 28A, a voice input is transcribed into text to produce an order receiving result of products in the product management service based on voice input, for example. In such a product management service, the received order contents are displayed on the left side of the screen for respective products while the receiving results corresponding to the order histories are displayed on the right side of the screen.

The following describes an example where a user uses the product management service. The user first utters the order of the sentence 2801 (one piece of product A and three pieces of product B in English) to input the voice. As a result, the translation service produces, as illustrated in FIG. 28A, the object O of the sentence 2801 and the action object having attributes of “one piece of product A” and “three pieces of product B”, and displays both objects.

The user then utters a change in order as the sentence 2802 (change the number of products B to one piece in English). In this change, when the sentence 2811 and the sentence 2812 are uttered with a pause therebetween, the input voice is wrongly recognized in that “wa” in the sentence 2811 is missing, and two sentences (the sentence 2821 and 2822) are produced as illustrated in FIG. 28B. In this case, the product management service determines that one piece of the product B is ordered on the basis of the recognition result of the sentence 2821, adds one piece of product B as the order, and updates the attribute of the action object indicating the number of products to “one piece of product A” and “four pieces of product B”. The product management service notifies the user of a certain message to request the user to designate the name of the product because the name of the product is unclear in the recognition result of the sentence 2812.

The user performs the editing operation (correct the changed content) as illustrated in FIG. 28C. The product management service connects the object O of the sentence 2822 to the object O of the sentence 2821

in accordance with the editing operation. The product management service then erases the two objects of the sentence 2821 and the sentence 2822 used for the correction and also erases the action object corresponding to the objects. The product management service refers to the attributes indicating the production times of the action objects managed by the object manager 14 and identifies the action object corresponding to the earliest time in the order histories. The product management service identifies the action object having the attributes of the order contents of “one piece of product A” and “three pieces of product B”, which are input first.

The product management service then updates the order content of the identified action object from “three pieces of product B” to “one piece of product B” on the basis of the connected object. The product management service then produces the action object having attributes of the order contents of “one piece of product A” and “one piece of product B”. In this way, the product management service produces a new action object corresponding to the object O of the sentence 2841. As a result, as illustrated in FIG. 28D, the product management service displays the object O of the sentence 2841 to update the screen display.

The product management service repeats such input and editing processing, and fixes the action object having the attribute of the latest production time as the order contents of the products when the order of the user is completed.

As described above, the editing apparatus 100 in the embodiment is applicable to the product management service using voice input, thereby making it possible to enhance the convenience of a user.

Apparatus

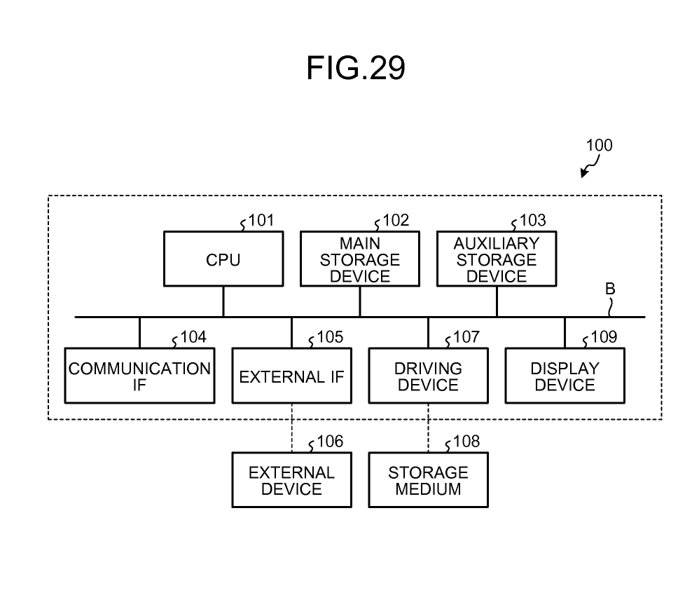

FIG. 29 is a schematic diagram illustrating an example of a structure of the editing apparatus 100 in the embodiments. As illustrated in FIG. 29, the editing apparatus 100 in the embodiments comprises a central processing unit (CPU) 101 and a main storage device 102. The editing apparatus 100 also comprises an auxiliary storage device 103, a communication interface (IF) 104, an external IF 105, a driving device 107, and a display device 109. In the editing apparatus 100, the respective devices are coupled with each other through a bus B. The editing apparatus 100 thus structured in the embodiments corresponds to a typical information terminal (information processing apparatus) such as a smartphone or a tablet. The editing apparatus 100 in the embodiments may be any apparatus that can receive user's operation and can perform the instructed processing in accordance with the received operation.

The CPU 101 is an arithmetic processing unit that controls the editing apparatus 100 totally and achieves the respective functions of the editing apparatus 100. The main storage device 102 is a storage device (memory) retaining programs and data in certain storage areas thereof. The main storage device 102 is a read only memory (ROM) or a random access memory (RAM), for example. The auxiliary storage device 103 is a storage device having a larger capacity storage area than that of the main storage device 102. The auxiliary storage device 103 is a nonvolatile storage device such as a hard disk drive (HDD) or a memory card. The CPU 101 reads out the programs and data from the auxiliary storage device 103 to the main storage device 102 and executes them so as to control the editing apparatus 100 totally and achieve the respective functions of the editing apparatus 100.

The communication IF 104 is an interface that connects the editing apparatus 100 to a data transmission line N. The communication IF 104 thus enables the editing apparatus 100 to perform data communication with other external apparatuses (other communication processing apparatuses) coupled to the editing apparatus 100 through the data transmission line N. The external IF 105 is an interface that enables data exchange between the editing apparatus 100 and an external device 106. The external device 106 is an input device receiving operation input (e.g., a “numeral keypad” or a “key board”), for example. The driving device 107 is a controller that writes data into and reads out data from a storage medium 108. The storage medium 108 is a flexible disk (FD), a compact disk (CD), or a digital versatile disk (DVD), for example. The display device 109, which is a liquid crystal display, for example, displays various types of information such as processing results on the screen. The display device 109 comprises a sensor detecting a touch or no touch on the screen (e.g., a “touch sensor”). With the sensor, the editing apparatus 100 receives various types of operation (e.g., “gesture operation”) through the screen.

The editing function in the embodiments is achieved by the cooperative operation of the respective functional modules described above as a result of the editing apparatus 100 executing an editing program, for example. In this case, the program is recorded in a storage medium readable by the editing apparatus 100 (computer) in an execution environment as a file in an installable or executable format, and provided as a computer program product. For example, in the editing apparatus 100, the program has a module structure comprising the respective functional modules described above and the respective modules are generated on the RAM of the main storage device 102 once the CPU 101 reads out the program from the storage medium 108 and executes the program. The manner of providing the program is not limited to this manner. For example, the program may be stored in an external apparatus connected to the Internet and may be downloaded through the data transmission line N. The program may be preliminarily stored in the ROM of the main storage device 102 or the HDD of the auxiliary storage device 103, and provided as a computer program product. The example is described herein in which the editing function is achieved by software implementation. The achievement of the editing function, however, is not limited to this manner. A part or all of the respective functional modules of the editing function may be achieved by hardware implementation.

In the embodiments, the editing apparatus 100 comprises a part or all of the input receiver 11, the display unit 12, the object controller 13, the object manager 14, the language processor 15, and the translator 16. The structure of the editing apparatus 100, however, is not limited to this structure. The editing apparatus 100 may be coupled to an external apparatus having some parts of the functions (e.g., the “language processor 15” and the “translator 16”) of those functional modules through the communication IF 104 and provide the editing function by the cooperative operation of the respective functional modules as a result of data communication with the coupled external apparatus. This structure enables the editing apparatus 100 in the embodiments to be also applied to a cloud environment, for example.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An editing apparatus, comprising:
a receiver configured to receive input data; and
a controller configured to produce one or more operable target objects from the input data, receive operation through a screen, and produce an editing result object by performing editing processing on the target object designated in the operation.

2. The apparatus according to claim 1, wherein
the controller includes a connector configured to connect two operable target objects, and
the connector is configured to connect a first target object to a second target object other than the first target object to produce a connected object corresponding to the editing result object when an occurrence position of an operation event is on the second target object, the first target object being designated with a single operation point that is present on the screen.

3. The apparatus according to claim 1, wherein
the controller includes a combiner configured to combine two or more operable target objects, and
the combiner is configured to combine the target objects designated with two or more operation points that are present on the screen to produce a combined object corresponding to the editing result object when a same target object is not designated with the operation points.

4. The apparatus according to claim 1, wherein
the controller includes a divider configured to divide one operable target object into a plurality of pieces, and
the divider is configured to produce a plurality of divided objects corresponding to the editing result objects by dividing the target object designated with two or more operation points that are present on the screen into a plurality of pieces when a same target object is designated with the operation points.

5. The apparatus according to claim 1, wherein the controller is configured to extract the target object designated with an operation point out of the target objects produced from the input data, on the basis of a determination whether an occurrence position of an operation event is on the target object.

6. The apparatus according to claim 1, further comprising a language processor configured to perform certain language processing on a character string associated with the target object, wherein
the language processor is configured to analyze a character string associated with the editing result object produced by the controller on a certain unit basis, and produce a corrected sentence by correcting a wrong portion on the basis of the analysis result.

7. The apparatus according to claim 2, wherein the connector is configured to divide a character string associated with the second target object into a plurality of characters or character strings at a border nearest to the occurrence position of the operation event, and insert between the characters or character strings a character string associated with the first target object to produce the connected object when the occurrence position of the operation event is on the character string associated with the second target object.

8. The apparatus according to claim 3, wherein the combiner is configured to obtain a gravity center of the target objects from center points of the target objects designated with the operation points, and combine the target objects designated with the operation points to produce the combined object when a maximum of distances between the gravity center and the target objects is equal to or larger than a threshold.

9. The apparatus according to claim 3, wherein the combiner is configured to sort the target objects designated with the operation points in ascending order of coordinates of the center points of the target objects, and combine the sorted target objects to produce the combined object.

10. The apparatus according to claim 4, wherein the divider is configured to cause the language processor to divide a character string associated with the target object designated with the operation points on a certain unit basis into a plurality of characters or character strings, determine dividing positions of the target object from positions of the operation points, produce the divided objects by combining the characters or the character strings in accordance with the dividing positions, and associate the produced divided objects with the operation points.

11. The apparatus according to claim 1, wherein the controller is configured to identify a connection direction or a combination direction of the target object, determine a connecting order or a combining order of the target objects in accordance with a predefined rule on the basis of a result of the identification, and connect or combine character strings associated with the target objects in the determined connecting order or the determined combining order.

12. The apparatus according to claim 1, wherein the controller is configured to determine a connecting order of the target object in accordance with a writing direction of a character string associated with the target object, and connect the character string associated with the target object in the determined connecting order.

13. The apparatus according to claim 1, wherein the controller is configured to produce the target object, and produce an object processed in synchronization with the produced target object.

14. The apparatus according to claim 1, further comprising a display unit configured to display the target objects or the editing result object, and receive the operation.

15. An editing method, comprising:
receiving input data;
producing one or more operable target objects from the input data;
receiving operation through a screen; and
performing editing processing on the target object designated in the operation to produce an editing result object.

16. A computer program product comprising a computer-readable medium containing a program executed by a computer, the program causing the computer to execute:
receiving input data;
producing one or more operable target objects from the input data;
receiving operation through a screen; and
performing editing processing on the target object designated in the operation to produce an editing result object.
